(19) United States
(12) Patent Application Publication
(10) Pub. No.: US 2012/0201096 A1
(43) Pub. Date: Aug. 9, 2012

(54) Methods and Apparatus to Process Time Series Data for Propagating Signals in A Subterranean Formation

(76) Inventors: Henri-Pierre Valero, Yokohama-Shi (JP); Sandip Bose, Brookline, MA (US); Jiaqi Yang, Belmont, MA (US); Bikash K. Sinha, Cambridge, MA (US); Tarek M. Habashy, Burlington, MA (US); Andrew Hawthorn, Missouri City, TX (US)

(21) Appl. No.: 13/497,252

(22) PCT Filed: Oct. 27, 2010
(86) PCT No.: PCT/IB10/02733

§ 371 Date: Mar. 21, 2012

Related U.S. Application Data
(60) Provisional application No. 61/255,476, filed on Oct. 27, 2009.

(51) Int. Cl. G01V 1/40

(52) U.S. Cl. 367/81

(57) ABSTRACT

Methods and apparatus to process time series data for propagating signals in a subterranean formation are disclosed. An example method described herein for processing measured data comprises receiving a time series of measured data obtained by sensing a propagating signal, the propagating signal having passed through a subterranean formation, transforming the time series of measured data to generate a time-frequency representation of the time series, and processing the time-frequency representation to at least one of reduce noise in the time frequency representation, or enhance a component of the propagating signal present in the time-frequency representation.

### RELATED APPLICATION(S)

This patent claims priority from U.S. Provisional Application Ser. No. 61/255,476, entitled “Methods and Apparatus to Process Time Series Data” and filed on Oct. 27, 2009. U.S. Provisional Application Ser. No. 61/255,476 is hereby incorporated by reference in its entirety.

### FIELD OF THE DISCLOSURE

This disclosure relates generally to data processing and, more particularly, to methods and apparatus to process time series data for propagating signals in a subterranean formation.

### BACKGROUND

In drilling or logging applications, acoustic measurements are often used to measure characteristics of the surrounding formation. Acoustic measurement techniques generally involve sensing acoustic waves generated by one or more acoustic sources and that have propagated through a subterranean formation. The sensed propagating signals can include one or more signal components, or modes, such as shear waves, compressional waves, flexural waves, Stoneley waves, etc. Formation properties can be measured from dispersion characteristics, such as attenuation, wavenumber, group delay, phase delay, etc., of the sensed propagating signals and/or their associated components/modes. Example formation properties that can be measured from such dispersion characteristics include shear slowness, mud slowness, compressional slowness, etc. In many real-world scenarios, the sensed propagating signals include noise, which can degrade the measured formation characteristics.

### SUMMARY

Example methods and apparatus to process time series data for propagating signals in a subterranean formation are disclosed herein. Example methods and apparatus described herein process and extract pertinent information from vector time series data obtained from an array of sensors recording propagating signals in the presence of noise. Example methods and apparatus disclosed herein integrate processing components that can denoise noisy time series, enhance extraction of information from time series and measure physical quantities, such as dispersion curves, characterizing a subterranean formation. Although example methods and apparatus are described in the context of logging-while-drilling (LWD), the methods and apparatus can be applied to any logging application, such as wireline logging, borehole seismic logging, surface seismic, etc.

An example method disclosed herein for processing measured data (such as measured acoustic data, measured electromagnetic data, etc.) includes receiving a time series of measured data obtained by sensing a propagating signal, where the propagating signal has passed through a subterranean formation. The example method also includes transforming the time series of measured data to generate a time-frequency representation of the time series. The example method further includes processing the time-frequency representation to at least one of reduce noise in the time frequency representation, or enhance one or more components of the propagating signal present in the time-frequency representation. In some examples, transforming the time series of measured data involves performing a wavelet transform (or any other operation capable of transforming a time series of data into a time-frequency representation, such as a Wigner Wille transform, a short time Fourier transform, etc.) on the time series of measured data to generate the time-frequency representation. In some examples, processing the time-frequency representation involves stacking a plurality of time-frequency representations generated for a respective plurality of time series of measured data, for example, corresponding to a respective plurality of propagating signals generated by successive firings of a source (such as an audio source, and electromagnetic source, etc.). In some examples, processing the time-frequency representation involves filtering the time-frequency representation. In some examples, the method additionally includes reconstructing a second time series (such as a second time series of acoustic data, electromagnetic data, etc.) from the processed time-frequency representation. In some examples, the method additionally includes determining a dispersion curve from the processed time-frequency representation. In some examples, the method additionally includes determining one or more properties of the subterranean formation from a dispersion curve determined from the processed time-frequency representation.

An example tangible article of manufacture disclosed herein stores example machine readable instructions which, when executed, cause a machine to at least receive a time series of measured data (such as measured acoustic data, measured electromagnetic data, etc.) obtained by sensing a propagating signal, where the propagating signal has passed through a subterranean formation. The example machine readable instructions, when executed, also cause the machine to transform the time series of measured data to generate a time-frequency representation of the time series. The example machine readable instructions, when executed, further cause the machine to process the time-frequency representation to at least one of reduce noise in the time frequency representation, or enhance one or more components of the propagating signal present in the time-frequency representation. In some examples, the machine readable instructions, when executed, additionally cause the machine to perform a wavelet transform (or any other operation capable of transforming a time series of data into a time-frequency representation, such as a Wigner Wille transform, a short time Fourier transform, etc.) on the time series of measured data to generate the time-frequency representation. In some examples, the machine readable instructions, when executed, additionally cause the machine to stack a plurality of time-frequency representations generated for a respective plurality of time series of measured data, for example, corresponding to a respective plurality of propagating signals generated by successive firings of a source (such as an audio source, and electromagnetic source, etc.). In some examples, the machine readable instructions, when executed, additionally cause the machine to filter the time-frequency representation. In some examples, the machine readable instructions, when executed, additionally cause the machine to reconstruct a second time series (such as a second time series of acoustic data, electromagnetic data, etc.) from the processed time-frequency representation. In some examples, the machine readable instructions, when executed, additionally cause the machine to determine a dispersion curve from the processed time-frequency representation. In some examples, the machine readable instructions, when executed, additionally cause the machine to determine one or more properties of the subterranean formation from a dispersion curve determined from the processed time-frequency representation.

An example data processor disclosed herein includes an example transformer to receive a time series of measured data (such as measured acoustic data, measured electromagnetic data, etc.) obtained by sensing a propagating signal, where the propagating signal has passed through a subterranean formation. The example transformer also is to transform the time series of measured data to generate a time-frequency representation of the time series. The example data processor also includes an example processor to process the time-frequency representation to at least one of reduce noise in the time frequency representation, or enhance one or more components of the propagating signal present in the time-frequency representation. In some examples, the transformer is a wavelet transformer that is to perform a wavelet transform (or any other operation capable of transforming a time series of data into a time-frequency representation, such as a Wigner Wille transform, a short time Fourier transform, etc.) on the time series of measured data to generate the time-frequency representation. In some examples, the data processor additionally includes a stacker to stack a plurality of time-frequency representations generated for a respective plurality of time series of measured data, for example, corresponding to a respective plurality of propagating signals generated by successive firings of a source (such as an audio source, and electromagnetic source, etc.). In some examples, the data processor additionally includes a filter to filter the time-frequency representation. In some examples, the data processor additionally includes a data analyzer to reconstruct a second time series (such as a second time series of acoustic data, electromagnetic data, etc.) from the processed time-frequency representation. In some examples, the data processor additionally includes a dispersion estimator to determine a dispersion curve from the processed time-frequency representation. In some examples, the data processor additionally includes a dispersion curve inverter to determine one or more properties of the subterranean formation from a dispersion curve estimated from the processed time-frequency representation.

### BRIEF DESCRIPTION OF THE DRAWINGS

FIG. 1 is a block diagram illustrating an example wellsite system capable of supporting the example methods and apparatus described herein to process time series data.

FIGS. 2A-D are a block diagram illustrating example seismic-while-drilling tools that may be used to implement the wellsite system of FIG. 1.

FIG. 3 is a block diagram illustrating an example sonic-while-drilling tool that may be used to implement the wellsite system of FIG. 1.

FIG. 4 illustrates an example receiver array that may be used to implement a seismic-while-drilling tool or a sonic-while-drilling for use in the wellsite system of FIG. 1.

FIG. 5 illustrates example receiver waveforms that may be determined from logging measurements obtained by the wellsite system of FIG. 1 using the receiver array of FIG. 4.

FIG. 6 illustrates an example data processor that may used to process receiver waveforms obtained using the receiver array of FIG. 4 in accordance with the methods and apparatus described herein.

FIG. 7 illustrates an example diversity stacking process that may be implemented by an example stacker included in the data processor of FIG. 6.

FIG. 8 illustrates example processing results achievable by the diversity stacking process of FIG. 7.

FIGS. 9-12 illustrate example operations of an example data analyzer included in the data processor of FIG. 6.

FIGS. 13-16 illustrate example filtering results achievable by an example filter included in the data processor of FIG. 6.

FIG. 17 is a flowchart representative of an example filtering process that may be implemented by the example filter included in the data processor of FIG. 6.

FIGS. 18-23 illustrate example processing performed by an example dispersion estimator included in the data processor of FIG. 6.

FIG. 24 is a flowchart representative of a first example inversion process that may be implemented by the example dispersion curve inverter included in the data processor of FIG. 6.

FIG. 25 is a flowchart representative of a second example inversion process that may be implemented by the example dispersion curve inverter included in the data processor of FIG. 6.

FIG. 26 illustrates example processing results achievable by the example dispersion curve inverter included in the data processor of FIG. 6.

FIG. 27 is a table listing example parameters of an example model used to generate synthetic data for processing by the data processor of FIG. 6.

FIG. 28 is a block diagram of an example processing system that may execute example machine readable instructions used to implement some or all of the processes of FIGS. 7, 17, 24 and 25 to implement the example data processor of FIG. 6.

### DETAILED DESCRIPTION

In the following detailed description, reference is made to the accompanying drawings, which form a part hereof, and within which are shown by way of illustration specific embodiments by which the invention may be practiced. It is to be understood that other embodiments may be utilized and structural changes may be made without departing from the scope of the disclosure.

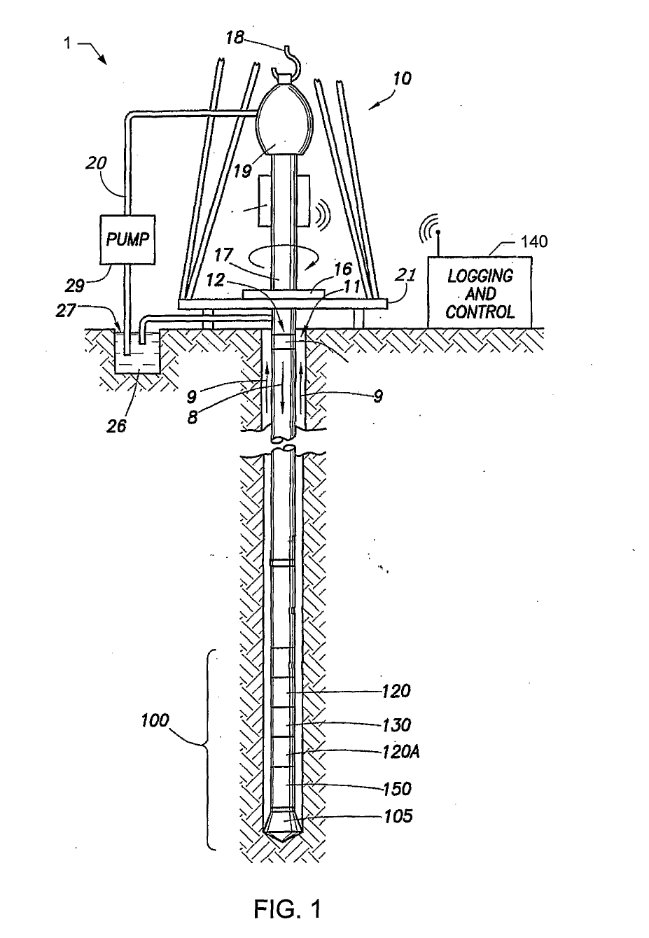

FIG. 1 illustrates an example wellsite system 1 in which the example methods and apparatus described herein to process time series data can be employed. The wellsite can be onshore or offshore. In this exemplary system, a borehole 11 is formed in subsurface formations by rotary drilling, whereas other example systems can use directional drilling.

A drillstring 12 is suspended within the borehole 11 and has a bottom hole assembly 100 that includes a drill bit 105 at its lower end. The surface system includes platform and derrick assembly 10 positioned over the borehole 11, the assembly 10 including a rotary table 16, kelly 17, hook 18 and rotary swivel 19. In an example, the drill string 12 is suspended from a lifting gear (not shown) via the hook 18, with the lifting gear being coupled to a mast (not shown) rising above the surface. An example lifting gear includes a crown block whose axis is affixed to the top of the mast, a vertically traveling block to which the hook 18 is attached, and a cable passing through the crown block and the vertically traveling block. In such an example, one end of the cable is affixed to an anchor point, whereas the other end is affixed to a winch to raise and lower the hook 18 and the drillstring 12 coupled thereto. The drillstring 12 is formed of drill pipes screwed one to another.

The drillstring 12 may be raised and lowered by turning the lifting gear with the winch. In some scenarios, drill pipe raising and lowering operations require the drillstring 12 to be unhooked temporarily from the lifting gear. In such scenarios, the drillstring 12 can be supported by blocking it with wedges in a conical recess of the rotary table 16, which is mounted on a platform 21 through which the drillstring 12 passes.

In the illustrated example, the drillstring 12 is rotated by the rotary table 16, energized by means not shown, which engages the kelly 17 at the upper end of the drillstring 12. The drillstring 12 is suspended from the hook 18, attached to a traveling block (also not shown), through the kelly 17 and the rotary swivel 19, which permits rotation of the drillstring 12 relative to the hook 18. A top drive system could alternatively be used.

In the illustrated example, the surface system further includes drilling fluid or mud 26 stored in a pit 27 formed at the well site. A pump 29 delivers the drilling fluid 26 to the interior of the drillstring 12 via a hose 20 coupled to a port in the swivel 19, causing the drilling fluid to flow downwardly through the drillstring 12 as indicated by the directional arrow 8. The drilling fluid exits the drillstring 12 via ports in the drill bit 105, and then circulates upwardly through the annulus region between the outside of the drillstring and the wall of the borehole, as indicated by the directional arrows 9. In this manner, the drilling fluid lubricates the drill bit 105 and carries formation cuttings up to the surface as it is returned to the pit 27 for recirculation.

The bottom hole assembly 100 includes one or more specially-made drill collars near the drill bit 105. Each such drill collar has one or more logging devices mounted on or in it, thereby allowing downhole drilling conditions and/or various characteristic properties of the geological formation (e.g., such as layers of rock or other material) intersected by the borehole 11 to be measured as the borehole 11 is deepened. In particular, the bottom hole assembly 100 of the illustrated example system 1 includes a logging-while-drilling (LWD) module 120, a measuring-while-drilling (MWD) module 130, a roto-steerable system and motor 150, and the drill bit 105.

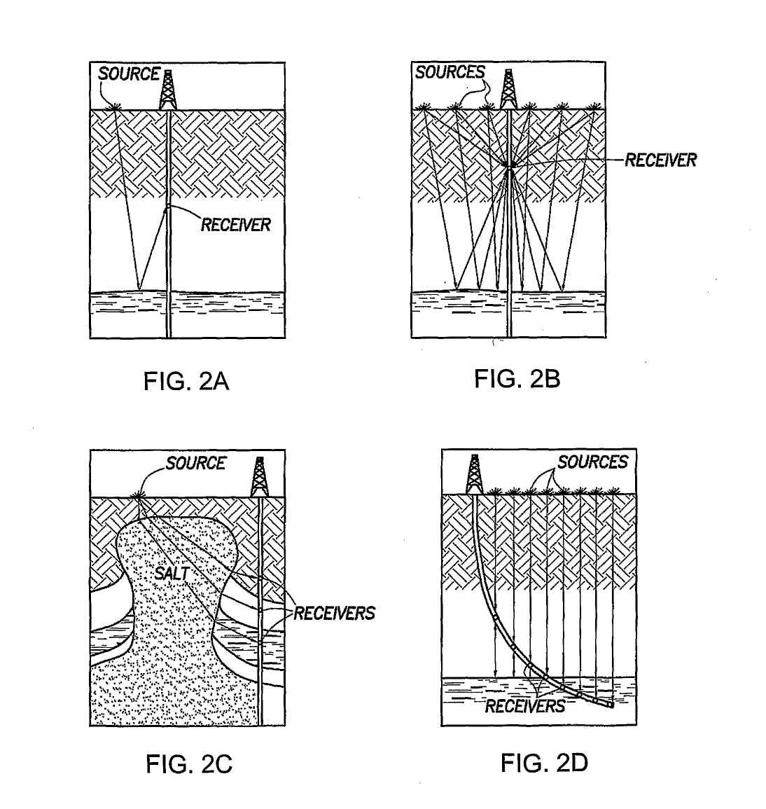

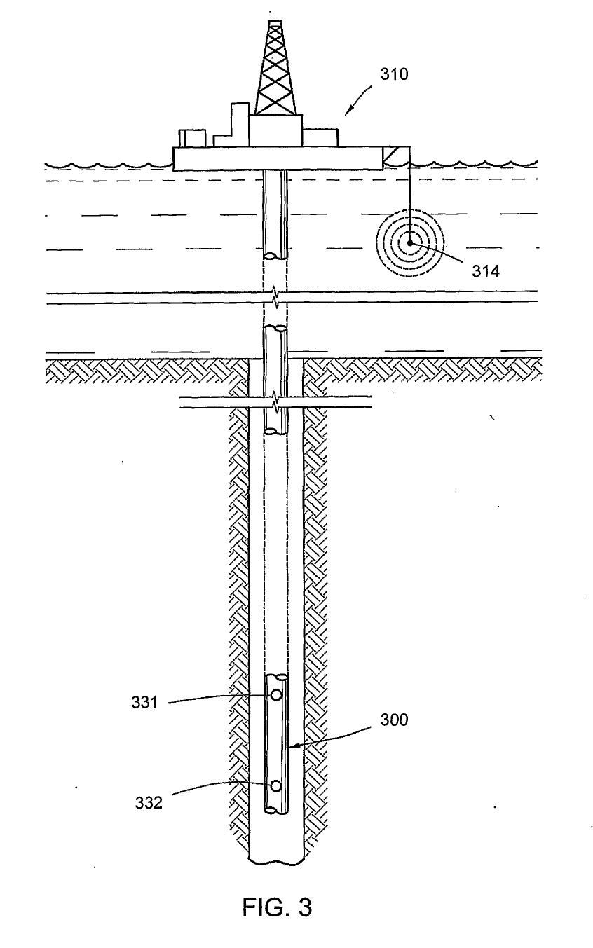

The LWD module 120 is housed in a drill collar and can contain one or a plurality of logging tools. It will also be understood that more than one LWD and/or MWD module can be employed, e.g. as represented at 120A. (References, throughout, to a module at the position of 120 can alternatively mean a module at the position of 120A as well.) The LWD module 120 includes capabilities for measuring, processing, and storing information, as well as for communicating with the surface equipment. In an example implementation, the LWD module 120 includes a seismic measuring device, examples of which are illustrated in FIGS. 2A-D and described in greater detail below. In another example implementation, the LWD module 120 includes a sonic measuring device, an example of which is illustrated in FIG. 3 and described in greater detail below.

The MWD module 130 is also housed in a drill collar and can contain one or more devices for measuring characteristics of the drillstring 12 and drill bit 105. The MWD module 130 further includes an apparatus (not shown) for generating electrical power to the downhole system. This may typically include a mud turbine generator powered by the flow of the drilling fluid, it being understood that other power and/or battery systems may be employed. In the illustrated example, the MWD module 130 includes one or more of the following types of measuring devices: a weight-on-bit measuring device, a torque measuring device, a vibration measuring device, a shock measuring device, a stick slip measuring device, a direction measuring device, and an inclination measuring device.

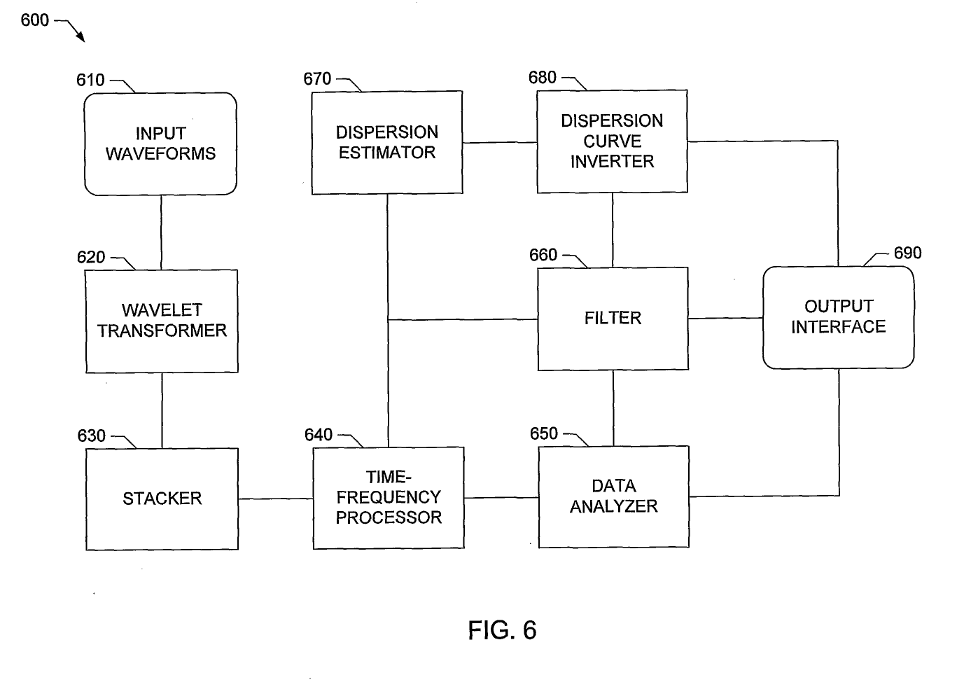

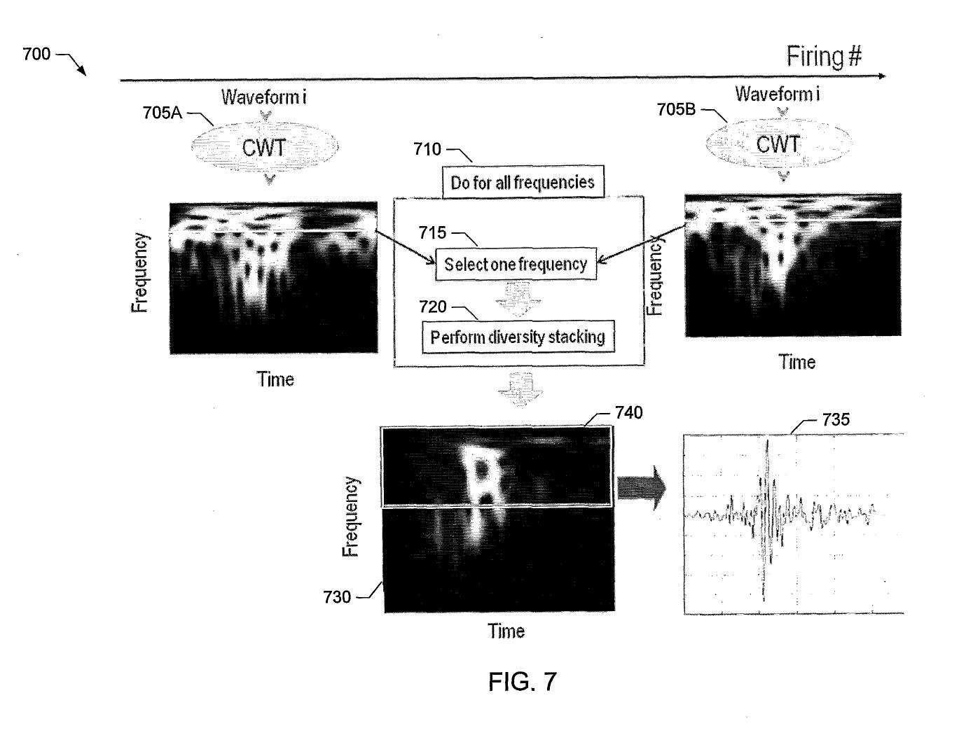

The wellsite system 1 also includes a logging and control unit 140 communicably coupled in any appropriate manner to the LWD module 120/120A and the MWD module 130. In the illustrated example, the logging and control unit 140 implements the example methods and apparatus described herein to process time series data representative of sensed propagating signals in a subterranean formation. An example logging unit that may be used to implement the logging and control unit 140 is illustrated in FIG. 6 and described in greater detail below.

FIGS. 2A-D illustrate example seismic-while-drilling tools that can be the LWD tool 120, or can be a part of an LWD tool suite 120A of the type disclosed in P. Breton et al., “Well Positioned Seismic Measurements,” Oilfield Review, pp. 32-45, Spring, 2002, incorporated herein by reference. The downhole LWD module 120/120A can have a single receiver (as depicted in FIGS. 2A and 2B), or multiple receivers (as depicted in FIGS. 2C and 2D), and can be employed in conjunction with a single seismic source at the surface (as depicted in FIGS. 2A and 2C) to support monopole acoustic logging or plural seismic sources at the surface (as depicted in FIGS. 2B and 2D) to support multipole acoustic logging. Accordingly, FIG. 2A, which includes reflection off a bed boundary, and is called a “zero-offset” vertical seismic profile arrangement, uses a single source and a single receiver; FIG. 2B, which includes reflections off a bed boundary, and is called a “walkaway” vertical seismic profile arrangement, uses multiple sources and a single receiver; FIG. 2C, which includes refraction through salt dome boundaries, and is called a “salt proximity” vertical seismic profile, uses a single source and multiple receivers; and FIG. 2D, which includes some reflections off a bed boundary, and is called a “walk above” vertical seismic profile, uses multiple sources and multiple receivers.

FIG. 3 illustrates a sonic logging-while-drilling tool that can be the LWD tool 120, or can be a part of an LWD tool suite 120A of the type described in U.S. Pat. No. 6,308,137, incorporated herein by reference. In the illustrated example of FIG. 3, an offshore rig 310 is employed, and a sonic transmitting source or array 314 is deployed near the surface of the water. Alternatively, any other suitable type of uphole or downhole source or transmitter can be provided. An uphole processor controls the firing of the transmitter 314. The uphole equipment can also include acoustic receivers and a recorder for capturing reference signals near the source. The uphole equipment further includes telemetry equipment for receiving MWD signals from the downhole equipment. The telemetry equipment and the recorder are coupled to a processor so that recordings may be synchronized using uphole and downhole clocks. A downhole LWD module 300 includes at least acoustic receivers 331 and 332, which are coupled to a signal processor so that recordings may be made of signals detected by the receivers in synchronization with the firing of the signal source.

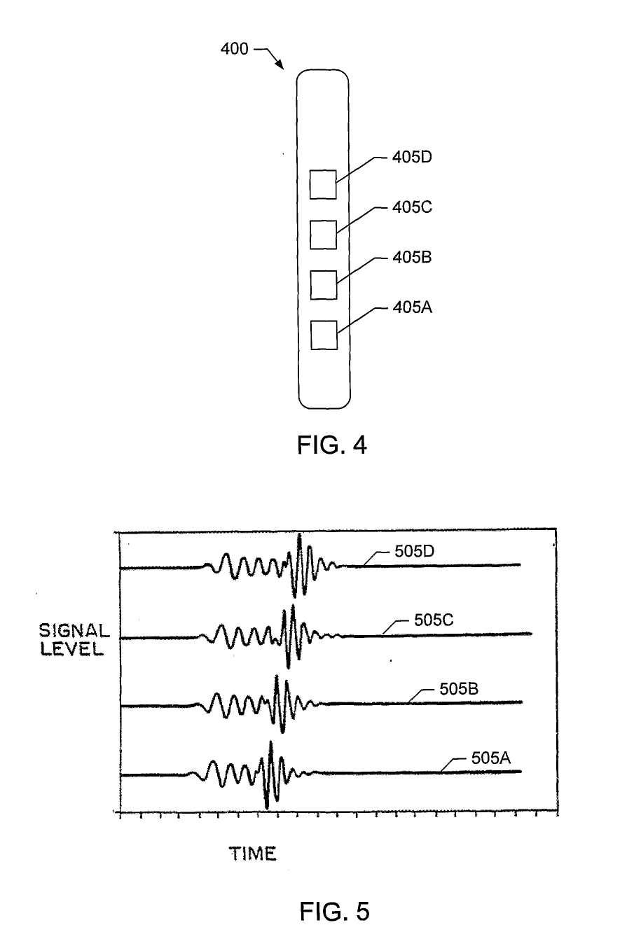

An example receiver array 400 that may be included in the example LWD tool 120 and/or 120A of FIGS. 1, 2 and/or 3 is illustrated in FIG. 4. The receiver array 400 of the illustrated example includes four acoustic receivers 405A-D. However, more or fewer receivers could be included in the receiver array 400. Each receiver 405A-D is configured to detect acoustic waves generated by one or more acoustic sources (not shown) and that propagate in a formation penetrated by a borehole in which the receiver array 400 is placed. The acoustic waveforms detected by the receivers 405A-D are staggered in time due to the spacing between the receivers 405A-D. For example, in the case of a monopole acoustic source, the receivers 405A-D detect monopole headwaves, including shear head waves, if present, that are nondispersive and, thus, the waveforms determined by each receiver are substantially similar except for a time delay. However, in the case of a quadrupole acoustic source, the receivers 405A-D detect quadrupole mode waves that are dispersive and, thus, the waveforms determined by each receiver may appear different. Examples of acoustic waveforms detected by the receivers 405A-D are depicted in FIG. 5.

FIG. 5 depicts four example acoustic waveforms 505A-D corresponding respectively to the receivers 405A-D included in the receiver array 400 of FIG. 4. The acoustic waveforms 505A-D are offset in time relative to each other due to the spacing between the receivers 405A-D. Additionally, the illustrated example waveforms 505A-D are dispersive as suggested by their different relative appearances.

FIG. 6 illustrates an example data processor 600 that can be implemented by the logging and control unit 140 of FIG. 1 to process time series data as described herein. In some examples, some or all of the processing performed by the data processor 600 could alternatively be performed downhole (e.g., in one or more of the LWD modules 120, 120A). As noted above, although the data processor 600 is described in the context of processing logging-while-drilling acoustic data, the data processor 600 can be used to process any type of measured data, such as wireline acoustic data, borehole seismic acoustic data, surface seismic acoustic data, measured electromagnetic data, etc. In other words, the times series data processed by the data processor 600 can correspond to any type of measured waveform data 610 (also referred to as waveforms 610) derived by sensing or otherwise detecting propagating signals.

As shown in FIG. 6, the data processor 600 includes an example wavelet transformer 620 to determine the complex continuous wavelet transform (CWT) of each of the set of recorded waveforms 610. For example, the set of waveforms 610 can correspond to the acoustic waveforms 505A-D sensed by the receivers 405A-D included in the receiver array 400. The wavelet transform maps a time signal into a two-dimensional (2D) function of time and scale. The scale is proportional to frequency and, for simplicity, is referred to as frequency in the remainder of the disclosure. Inclusion of the wavelet transformer 620 enables other processing to be performed in this 2D domain. In some examples, the data processor 600 additionally or alternatively includes other transformers (not shown) that can determine these 2D time-frequency representations of the input waveforms 610 using other operations, such as a Wigner Wille transform, a short time Fourier transform, etc. Example operation of the wavelet transformer 620 is described in further detail below.

The data processor 600 also includes a stacker 630 to perform a stacking operation on recorded waveforms that have been transformed into a time frequency map using the wavelet transformer 620. Stacking is employed to attenuate noise and simultaneously amplify the coherent signal(s) included in the recorded waveforms 610. The stacking operation can be useful in noisy environment as found, for example, in logging while drilling applications. Example operation of the stacker 630 to perform diversity stacking in the wavelet domain, which can boost the coherent signal relative to noise and, thereby, improve signal-to-noise ratio (SNR) is described in further detail below. Note that the example stacking operations performed by the stacker 630 do not assume any particular type of data to be stacked and, therefore, have general application to a variety of drilling, logging, measurement and other applications.

The data processor 600 further includes a time-frequency processor 640 to invoke one or more processing elements that use the time-frequency representation of the stacked signal to analyze and better understand the recorded data. For example, the time-frequency map allows evaluation of the frequency content of various waves recorded during the logging operation. Additionally, the time-frequency map can be used to determine if one or more of the waveform components are dispersive (e.g., exhibit variation of frequency with time) or not.

The data processor 600 also includes a data analyzer 650 that can be invoked by the time-frequency processor 640 to perform data analysis linked to the intrinsic properties of the transformation that increases the dimensionality of the signal representation, (i.e., from a one dimension (1D) representation to a 2D representation). Example operation of the data analyzer 650 is described in further detail below in the context of an application on synthetic data.

The data processor 600 also includes a filter 660 that can be invoked by the time-frequency processor 640 to perform filtering to separate signals of interest from noise. As describe in further detail below, the complex continuous wavelet transform is suitable for filtering components separated in the time-frequency domain (although the example described herein are applicable to filtering time-frequency representations generated using operations other than the continuous wavelet transform, such as time-frequency representations generated using a Wigner Wille transform, short time Fourier transform, etc). For example, the filter 650 can exploit a property of the reproducing kernel that allows design and implementation of sharp filters to separate closely spaced components in the time-frequency domain. Such cases are commonly found in borehole acoustic data.

The data processor 600 further includes a dispersion estimator 670 that can be invoked by the time-frequency processor 640. A potentially important piece of information in borehole acoustic analysis is the set of dispersion curves of the propagating borehole modes included in the received signal. A dispersion curve characterizes the variation of slowness (or velocity) with frequency of one or more of the modes included in the sensed propagating signal(s). The set of dispersion curves can provide a useful representation of an array of acoustic data in the slowness-frequency domain. This type of representation can be useful in understanding the characteristics of the rock formation surrounding a borehole. However, automatic extraction of dispersion curves can be difficult due to the complexity of the recorded signals, the presence of noise etc. In the illustrated example, the dispersion estimator 670 is able to extract group and phase slowness directly from the wavelet representation of the recorded data. Example operation of the dispersion estimator 670 on real data is described in further detail below.

The data processor 600 also includes a dispersion curve inverter 680 that can be invoked by the time-frequency processor 640 to perform an inversion operation to estimate shear slowness from extracted dispersion curves determined by the dispersion estimator 670. For example, the dispersion curve inverter 680 can be used to extract shear slowness measurements from a quadrupole dispersion curve. Note that, although the dispersion curve inverter 680 is described in the context of operating on quadrupole data, the dispersion curve inverter 680 can additionally or alternatively operate on any other acoustic mode or set of modes, such as flexural, Stoneley, leaky modes, etc. In addition, dispersion curve extraction as performed by the dispersion estimator 670 and wavelet filtering as performed by the filter 660 can be combined and the result provided to the dispersion curve estimator 680 to extract the signals and/or formation parameters of interest in the case of complicated signals corrupted by a variety of noise and interference.

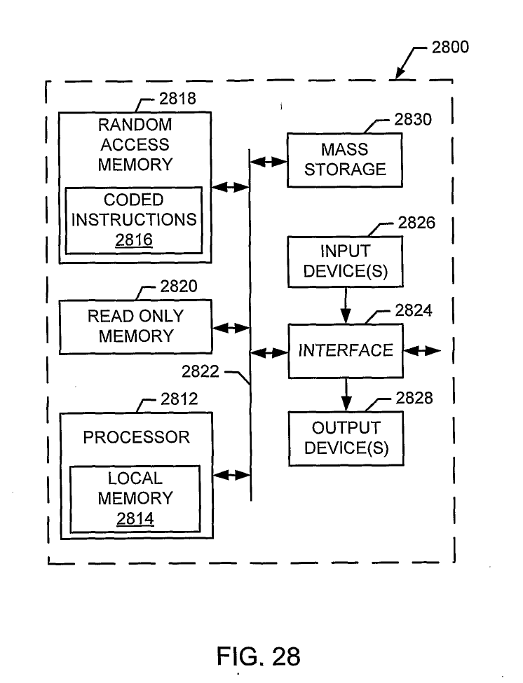

An output interface 690 is included in the data processor 600 to enable the processed waveforms, estimated dispersion curves, measured formation parameters, etc., determined by the various components of the data processor 600 to be output in any appropriate format. For example, the output interface 690 can be implemented by the example interface circuit 2824 and one or more of the example output devices 2828 included in the example processing system 2800 of FIG. 28, which is described in greater detail below.

As described above, the wavelet transformer 620 performs continuous wavelet transforms on the recorded waveforms 610. The continuous wavelet transform is a transformation allowing the decomposition of an arbitrary time or space dependent signal, s(p), into elementary contributions of functions called wavelets obtained by dilation and translation of a “mother” or analyzing wavelet g(p). In this disclosure, the terms “waveforms,” “signal,” “function,” and “time series” are used to refer to data collected by any of a set of receivers (e.g., the receivers 405A-D in the receiver array 400) at a plurality of sampling points in time or space. Note that the data can be viewed as a series (e.g., “time series”) that represents the evolution of the observed quantity as a function of time (or space), when plotted out versus time (or space), as tracing out the shape of the acoustic waves received (e.g., “waveform”), and also as containing information to be extracted (e.g., “signal”). For the purposes of this disclosure, let s(p) be an arbitrary time or space dependent signal and g(p) the chosen complex and progressive analyzing wavelet to be used to study wave propagation phenomena, and let p be the time or space variable. The continuous wavelet transform S(b, a) of a function s(p) is the scalar product of this signal by the members of the wavelet family obtained from g, using dilation (contraction) and translation operators given as

$${T}^{b} {D}^{α} [ g ( p ) ] = {a}^{- q} g ( \frac{p - b}{a} ) ,$$

which results in Equation 1:

$$S ( b , a ) = < g ( b , a ) , s ( p ) >= {a}^{- q} \int s ( p ) \overline{g} ( \frac{p - b}{a} ) d p \qquad Equation 1$$

In Equation 1, g(b, a) is g dilated in time by a (a>0) and translated in time by b, homogeneous to the time in this case, (bεR), as given by Equation 2:

$$g ( b , a ) = {T}^{b} {D}^{a} [ g ( p ) ] = {a}^{- q} g ( \frac{p - b}{a} ) \qquad Equation 2$$

In Equation 1 and Equation 2, g̅ is the complex conjugate and q=1, ½ for L₁ and L₂ normalization respectively. In Equation 1 and Equation 2, a and b are respectively the scale (or dilation) parameter, which can be interpreted as a zoom and a translation parameter. Small dilations will be related to the high frequencies and vice versa. To correctly define and give a physical meaning to the phase of the wavelet coefficients, the analyzing wavelet should satisfy the analytic or progressive property (i.e.: ĝ(ω)=0, for negative (spatial or time) frequency components (ω<0)). The calculation of the wave fronts of different wave contributions and their spectral components can be performed precisely without artifacts or interferences due to the absence of Fourier components on the negative axis.

There exists some flexibility in the choice of the analyzing wavelet, but it should preferably satisfy the admissibility condition deduced from the isometric property of the transform in the following sense: there exists for every s(t) a constant c_{g} depending only on the wavelet g such that:

$$\begin{matrix}\int {\vert s ( t ) \vert}^{2} d t = {c}_{g}^{- 1} \int \int {\vert S ( b , a ) \vert}^{2} \frac{d a d b}{{a}^{2}} , \\ and \text{:} & Equation 3 \\ {c}_{g} = 2 π \int \frac{{\vert \hat{g} ( ω ) \vert}^{2}}{\vert ω \vert} d ω < ∞ .. & Equation 4\end{matrix}$$

In Equation 4, ĝ is the Fourier transform of g with ω as the dual variable of the time t and the inequality on the right is the admissibility condition. It follows that g is of zero mean (∫g(t)dt=0 or ĝ(0)=0). If this condition is satisfied, there exists an inversion formula which reconstructs the analyzed signal (e.g., as described in Grossmann, A. and Morlet, J., 1984, Decomposition of Hardy functions into square integrable wavelets of constant shape, SIAM—J. Math. Anal., 15, 723-736), yielding:

$$s ( t ) = Re [ {c}_{g}^{- 1} \int \int S ( b , a ) {a}^{- 1 / 2} g ( \frac{t - b}{a} ) \frac{d a d b}{{a}^{2}} ] \qquad Equation 5$$

where Re[.] represents the real part.

Since the CWT is non-orthogonal, [symbol] g(b,a),g(b′,a′) [symbol] ≠0. There exists a reproducing kernel N_{g} defined from Equation 2 and Equation 4 as:

N_{g}(b,a,v,u)=c_{g}⁻¹ [symbol] g(b,a),g(v,u) [symbol] . Equation 6

In some examples, a progressive analyzing wavelet such as a Morlet type in which

$$g ( t ) = exp ( {iω}_{0} t ) exp ( \frac{- {t}^{2}}{2 {β}^{2}} ) ,$$

with ω₀=2π and β=1 yielding ĝ(ω)≈0 when ω<0 is selected. The Morlet wavelet is not a true wavelet in that its integral is not zero. However, for a large enough ω₀ (in practice larger than 5), the integral of the Morlet wavelet is small enough that it can be used numerically as if it were a wavelet (e.g., as described in Grossmann, A., Kronland-Martinet, R., Morlet, J., 1989, Reading and understanding continuous wavelet transform. Wavelet, Time-frequency Methods and Phase Space, Ed. J. M. Combes, A. Grossmann, P. Tchamitchian, Springer-Verlag, Berlin). Using results from Gradshteyn, I. S. and Ryzhik, I. M., 1990, Table of Integrals, Series and Products, Academic Press, New York, the modulus and the phase of the reproducing kernel has the explicit form of Equation 7:

$$\vert {N}_{g} ( v , u ; b , a ) \vert = \frac{β}{{c}_{g}} \sqrt{\frac{2 π ua}{{u}^{2} + {a}^{2}}} exp ( - \frac{1}{2} \frac{{ω}_{0} {{β}^{2} ( a - u )}^{2} + {( v - b )}^{2} / {β}^{2}}{{u}^{2} + {a}^{2}} ) ; \\ arg [ {N}_{g} ( v , u ; b , a ) ] = \frac{{ω}_{0} ( b - v ) ( u + a )}{{u}^{2} + {a}^{2}} \qquad Equation 7$$

From Equation 1 and Equation 6, wavelet coefficients satisfy the following reproducing equation:

$$S ( v , u ) = \int S ( b , a ) {N}_{\dot{g}} ( v , u , b , a ) \frac{d b d a}{{a}^{2}} . \qquad Equation 8$$

This allows the use of the interpolation formula introduced in Grossmann, A., Kronland-Martinet, R., Morlet, J., 1989, Reading and understanding continuous wavelet transform. Wavelet, Time-frequency Methods and Phase Space, Ed. J. M. Combes, A. Grossmann, P. Tchamitchian, Springer-Verlag, Berlin, to reconstruct an approximate value of the CWT from the value of the Discrete Wavelet Transform (DWT).

Stacking, such as that implemented by the stacker 630, is performed in seismic data processing and involves combining a collection of many signals into a single trace to attenuate the noise and simultaneously amplify the coherent signal in a desired gather. For example, consider a trace composed of a signal of interest s(t) combined with a noise d(t) such that:

trace_{i,j}(t)=s_{i,j}(t)+d_{i,j}(t) Equation 9

In Equation 9, trace_{i,j}(t) is the i-th trace in the j-th gather, s_{i,j}(t) is the i-th signal trace in the j-th gather, and d_{i,j}(t) is the random noise. Let N and M represent the number of traces in each gather and the total number of gathers, respectively. For the standard stacking operation, the signal of interest s(t) is estimated by averaging the traces within the j-th gather (e.g., as described in Mayne, W. H., 1967, Practical consideration in the use of common reflection point techniques, Geophysics, 32, pages 225-229), which can be expressed as:

$${s}_{j} ( t ) = \frac{1}{N} {\sum }_{i = 1}^{N} {trace}_{i , j} ( t ) \qquad Equation 10$$

However, this approach provides the optimal unbiased estimate of s(t) only when the noises in all the traces are uncorrelated (spatially), Gaussian, stationary (temporally), and of equal noise variances. Robinson, J. C., 1970, Statistically optimal stacking of seismic data, Geophysics, 35, pages 436-446, proposes to use a signal-to-noise-ratio (SNR) based weighted stack to further minimize the noise, which can be expressed as:

$${s}_{j} ( t ) = \frac{1}{{\sum }_{i = 1}^{N} {w}_{i , j}} {\sum }_{i = 1}^{N} {w}_{i , j} \times {trace}_{i , j} ( t ) \qquad Equation 11$$

### In Equation 11,

$${w}_{i , j} = \frac{1}{{σ}_{i , j}^{2}}$$

where σ_{i,j}² denotes the variance of the noise corrupting the i-th trace from the j-th gather. Given the noise variances, the above technique can be an optimal unbiased linear estimate of sⱼ(t) if uncorrelated (spatially) and stationary (temporally) noise is assumed. However, the performance of this technique is strongly linked to the ability of the user to properly and reliably estimate the variance of the noise. U.S. Pat. No. 3,398,396 showed that it can be more robust to weight the stack based on signal amplitude and noise power. In practical implementations with common signal amplitude, the weight that is used is the inverse of the total power, which is calculated using a long, moving window. In this case, Equation 13 is used but the weighting factor w_{i,j} is equal to the power of the noise. This stacking operation outlined above for within gather stacking can also be applied across gathers depending on the application.

In contrast to the preceding stacking approaches, the stacker 630 performs the stacking operation in the continuous wavelet domain. First, each of the waveforms 610 recorded for the various firings are continuous wavelet transformed by the wavelet transformer 620, as explained above, into a 2D map of time and frequency. The stacker 630 then performs diversity stacking frequency by frequency on the wavelet coefficients in these 2D wavelet maps. At each frequency, the formula of Equation 11 is applied and a stacked set of wavelet coefficients is obtained. The stacker 630 repeats this operation for all frequencies of the wavelet transform map. In some examples, the stacker 630 estimates the weighting factor for each frequency by considering a window at the beginning of the signal to estimate the noise power and taking into account the correlation across frequencies.

After this stacking has been performed, the stacker 630 applies the inverse wavelet transform of Equation 5 to the stacked wavelet map and obtains a stacked signal in the time domain with improved (or potentially improved) signal-to-noise ratio (SNR). In some examples, the stacker 630 selects a part of the wavelet stacked map to reconstruct the time signal. In such examples, the stacker 630 applies the reconstruction formula of Equation 5 on only a part of the stacked wavelet map (e.g., where energy is maximum), which is equivalent to performing a filtering operation. This stacking approach allows the stacker 630 to efficiently stack the data jointly as a function of frequency and time, thereby minimizing overlap with interference compared to approaches confined to the time or frequency domain alone that can be prone to overlapping arrivals in the respective domains.

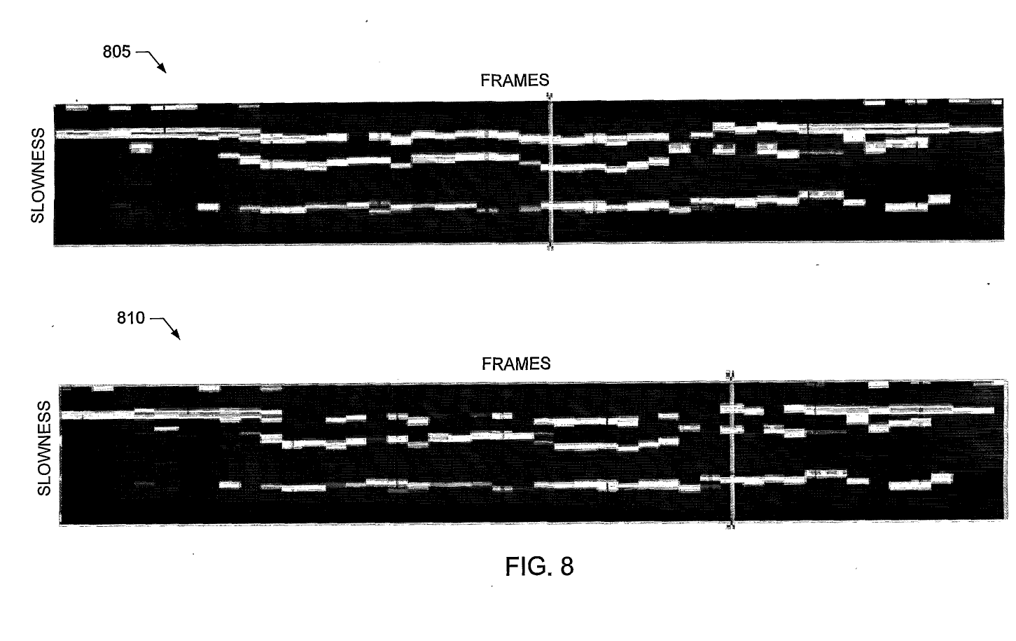

FIG. 7 illustrates an example process 700 executed by the stacker 630 to perform diversity stacking in wavelet domain. FIG. 8 illustrates a comparison of diversity stacking in wavelet domain as performed by the stacker 630 versus conventional stacking. As illustrated in FIG. 8, diversity stacking in the wavelet domain can provide higher coherence and more continuous logs as compared to the results obtained with conventional stacking.

In the process 700 of FIG. 7, each recorded waveform for different firing is transformed into a time frequency representation (blocks 705A-B). Then each frequency of each map is stacked together using diversity stacking (blocks 715-720). This operation is conducted until all frequencies have been stacked (block 710). After all frequencies have been stacked, the stacker 630 obtains a stacked wavelet map (730) that is transformed by the stacker 630 into a time signal (735) using the reconstruction formula of the continuous wavelet transform. The region 740 corresponds to an example zone where the reconstruction formula is applied to reconstruct the temporal signal. This operation is equivalent to perform a filtering operation. It is also possible to additionally restrict the reconstruction zone in time.

In FIG. 8, a semblance coherence log 805 is illustrated for diversity stacking in wavelet domain as performed by the stacker 630. Another semblance coherence log 810 is illustrated for standard stacking. As illustrated in FIG. 8, the log 805 diversity stacking exhibits higher coherency and better continuity than the log 810 for standard stacking.

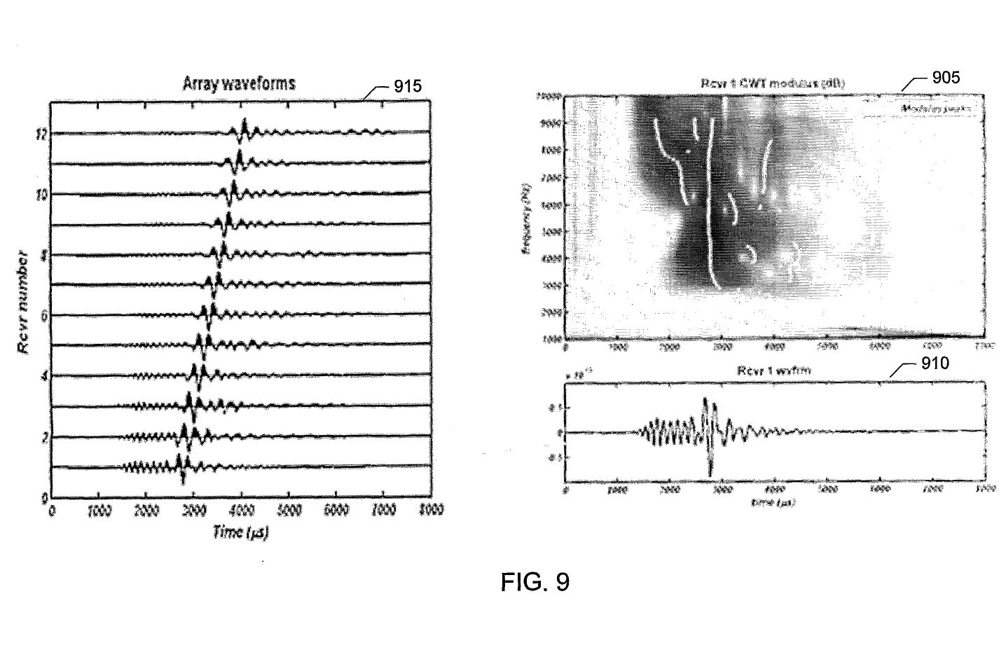

Example operation of the data analyzer 650 to analyze time series waveform data using the continuous wavelet transform is now described. FIG. 9 illustrates a continuous wavelet transform (CWT) map 905 of a waveform 910 from an array 915. The wavelet transform maps a one dimensional signal into a two dimensional (time-frequency/scale) plane of coefficients as shown in the CWT map 905 of FIG. 9. In the illustrated example, the modulus of the complex CWT coefficients of the first receiver are shown on a dB scale. The modulus peaks (maxima) are also plotted on the map.

The resulting increase in dimensionality afforded by the CWT map 905 can result in the separation of components of real physical signals on the time-frequency plane. It then becomes possible to analyze the received signals using a single mode approach by operating in the time-frequency or time-scale domain. In addition, the CWT map 905 can improve interpretation of the behavior of the recorded signal in a borehole, (e.g., in determining dispersion, attenuation etc.).

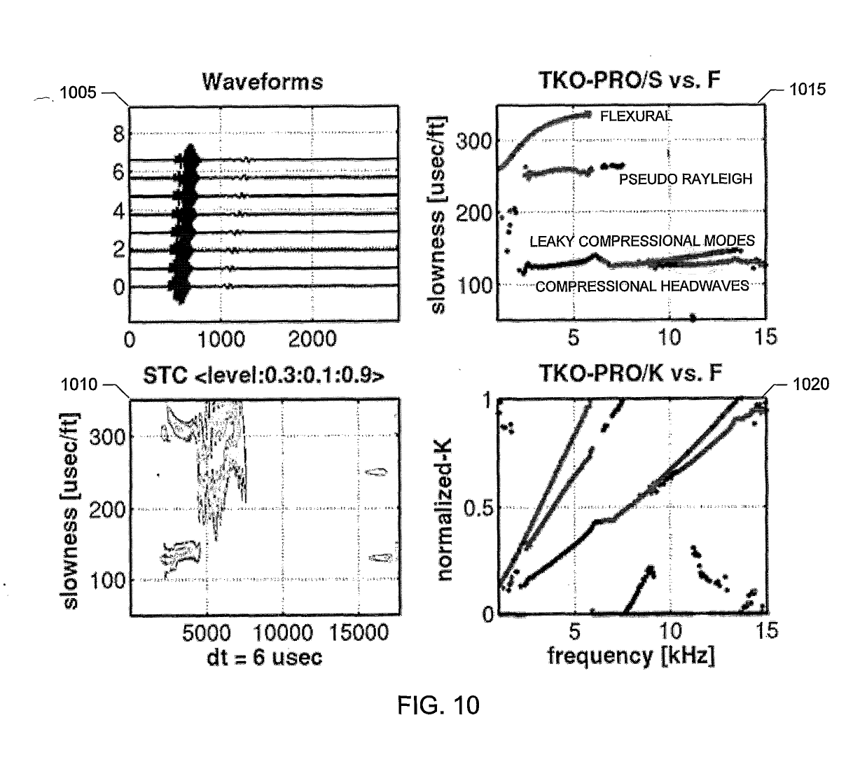

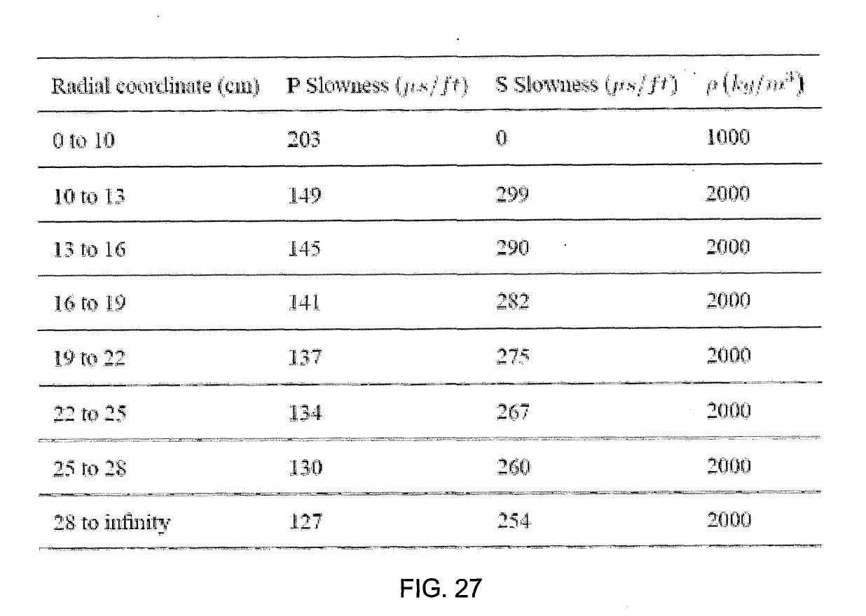

To demonstrate the utility of the wavelet transform for interpreting and filtering acoustic data, consider an example with synthetic data generated using an example semi analytical method proposed by Lu, C. C., and Liu, Q. H., 1995, A three-dimensional dyadic Green's function for elastic waves in multilayer cylindrical structures, J. Acoust. Soc. Am., 98, 2825-2835. The example model used for generating the synthetic data corresponds to a centered dipole source excited at 10 kHz in an 8 inch borehole surrounded by an altered profile. The table in FIG. 27 presents the parameters used to generate the altered profile. Modeled data as collected by an array of 8 receivers (e.g., such as the receiver array 400) and processed by the data analyzer 650 into the slowness-time and slowness-frequency domains are presented in FIG. 10. For example, FIG. 10 includes a graph 1005 of the modeled waveforms and a graph 1010 of the slowness-time semblance plane (e.g., as described in Kimball, C. V, and Marzetta, T. L., 1987, Semblance processing of borehole acoustic data, Geophysics, 49, 530-544). In other words, the graph 1005 presents the calculated waveforms on 8 receivers labeled 0 to 7, and a graph 1015 illustrates the dispersion representation of these waveforms in the frequency slowness domain. The slowness-frequency graph 1015 (e.g., as described in Lang, S. W., Kurkjian, A. L., McClellan, J. H., Morris, C. F., and Parks, T. W., 1987, Estimating slowness dispersion from arrays of sonic logging waveforms, Geophysics, 52, 530-544.) and a graph 1020 containing frequency-wavenumber plots are also included in FIG. 10. That is, the graph 1010 provides a slowness time representation of the data, whereas the graph 1020 provides a wavenumber-frequency (K vs. F) view of the data.

The analysis of these plots reveals the existence of a borehole flexural mode (component), a pseudo-Rayleigh mode and a leaky-compressional mode, together with a non dispersive compressional headwave. The leaky-compressional mode has strong amplitude relative to the flexural arrival of interest. Note also that when these arrivals are simultaneously present at a given frequency, standard frequency filtering will have difficulty isolating them. This result can become an even greater concern if arrivals are also close in slowness, as is the case for the flexural and the pseudo-Rayleigh modes, for example. Time-frequency analysis is able to analyze and separate the various components of the signal.

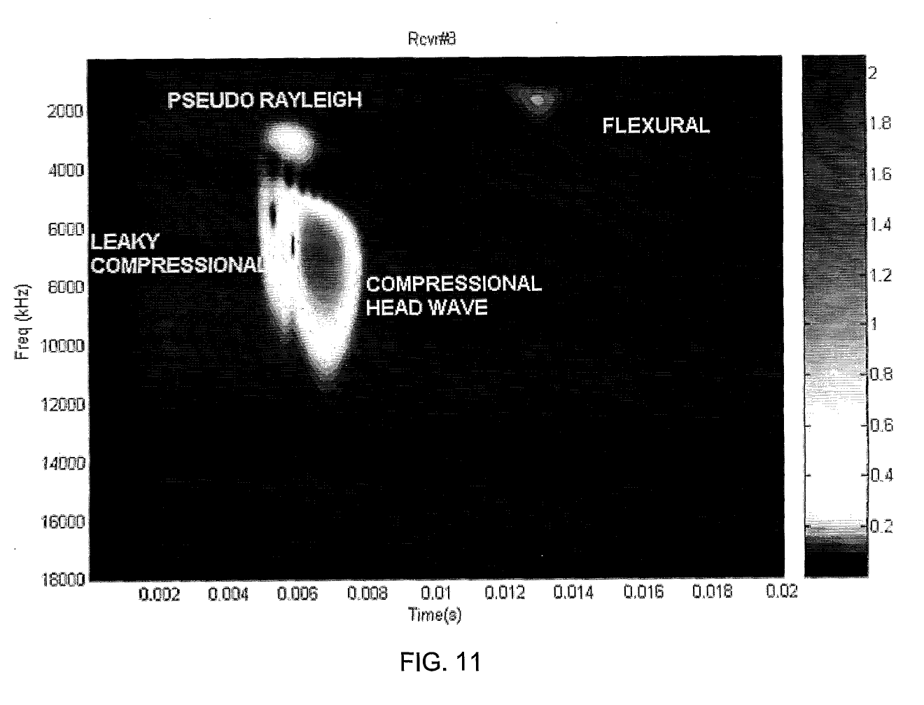

For example, the data is initially processed by the wavelet transformer 620 using the wavelet transform (with possible stacking as performed by the stacker 630). FIG. 11 presents the wavelet transform of the waveform number 8 of FIG. 9 as output by the data analyzer 650. The X and Y axis represent, respectively, the time (s) and the frequency (Hz), whereas the third dimension is similar to energy. Note how it is relatively easy to interpret the various components propagating across the array and to obtain information regarding their time-frequency support and energy. For example, the 1D waveform is now represented in a 2D domain making it possible to discriminate the different components (modes) composing the waveform. Furthermore, the various components are easily observable even if they are close in frequency, time or both.

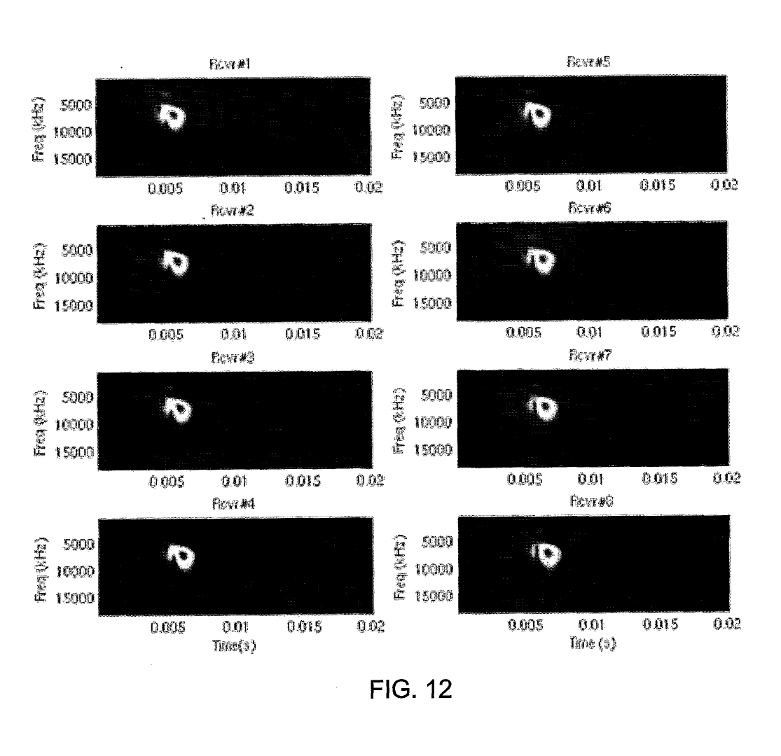

For example, FIG. 11 illustrates a flexural component that is weak and can be difficult to observe in the time domain. However in the time frequency plane, the flexural is easily observed, as are the others components, (i.e., the compressional head wave, the leaky compressional mode and the pseudo-Rayleigh mode). Furthermore, the dispersive character of some of the arrivals (flexural, leaky-P) is also clearly visible. It is important to keep in mind that this analysis has been done only with one waveform, whereas for the matrix pencil method the array of waveforms (e.g., the eight waveforms of FIG. 10) are to be processed. FIG. 12 presents the wavelet transform map of the eight modeled waveforms of FIG. 10 and modulus of the wavelet transform for the eight waveforms as output by the data analyzer 650, which illustrates the propagation of the various components. That is, the wavelet transform maps of FIG. 12 separate the various modes present in the data and follow their propagation in the time-frequency-space domain. As illustrated in FIGS. 9-12, CWT representation facilitates the interpretation and analysis of complex data, such as borehole acoustic waveforms. Note that this analysis is independent of the type of data considered and could also be applied to borehole or surface seismic data, as well as other types of data.

Example operation of the filter 660 to perform filtering using the continuous wavelet transform is now described. Consider a signal comprising the sum of in signals fᵢ of various spectral contents, and/or arrival times. Assume that these waves are not isolated but interfere to some extent with each other. The wavelet transform of this signal yields, due to the linearity property of the transform, a spread of the signal's energy in the time-frequency space given by the CWT coefficients:

$${S}_{s} ( b , a ) = {\sum }_{i = 1}^{m} {S}_{{f}_{i}} ( b , a ) \qquad Equation 12$$

To extract a component fᵢ(t) from the total wavelet coefficient Sₛ, the filter 660 employs a mask M_{f}_{ᵢ}(b,a) in the half-plane (a, b) and uses, in some examples, the reconstruction formula of the continuous wavelet transform on the pattern of interest. There are various approaches that can be used by the filter 660 to automatically define the mask depending on the complexity of the studied signal. One approach involves defining a threshold based on the maximum of energy contained in the time-frequency space. However, this approach may not be optimal in the presence of strong noise in the data. Another approach uses image processing techniques, such as pattern recognition (e.g., as described in Canny, John, 1986. A Computational Approach to Edge Detection, IEEE Trans on Pattern Analysis and Machine Intelligence, 8(6), 679-698; Lim, Jae S., 1990, Two-Dimensional Signal and Image Processing, Englewood Cliffs, N.J.: Prentice Hall, 478-488;and Parker, James R., 1997, Algorithms for Image Processing and Computer Vision. New York: John Wiley & Sons, Inc), to identify the mask for different components present in the time-frequency map and to extract them individually. For example, to extract the same component propagating across an array, a mask defined for a component of the waveform at the first receiver can be dynamically modified to extract the component at the second station and so on. In practice, the form of the mask at the first waveform is used as a-priori information (e.g., which is pre-configured). This approach can yield reasonable results but, because it is applied blindly, can increase computation time as no information regarding the various components to be separated is known initially. One way to address this issue is to use some a-priori information based on the physics of the components to be extracted. In that case, it becomes easier and faster to predefine the form of the mask to perform the filtering. In practice, it is reasonable to consider that a user will have some information on the components to be filtered (frequency, slowness, etc.). This point is further illustrated below in the context of combining filtering with dispersion curve extraction.

Continuing, the wavelet filtering implemented by the filter 660 involves applying a mask as described above on the time-scale half-plane and extracting the signal fᵢ(t) from Sₛ(a, b) by using the properties of the reproducing kernel to recover the corresponding coefficients S_{f}_{ᵢ}(a, b) and reconstructing the desired component fᵢ(t) from the latter. Each mask corresponds to a polygon function h associated with each wave in the half-plane (b, a) such that.

M_{fi}(b,a)=0,Eₛ_{_{fi}}(b,a)<χ

M_{fi}(b,a)=1,Eₛ_{_{fi}}(b,a)≧χ Equation 13

In Equation 13, χ is a threshold.

Let Dₕ be the domain defined by the polygon function h. The energy pattern related to a component fᵢ(t) can then be expressed as Eₛ_{_{fi}}=M_{f}_{ᵢ}(b, a)Eₛ_{ₛ}|Dₕ. The energy for the component fᵢ(t) is then bounded by:

$${E}_{{S}_{fi}} = \int \int {\vert {S}_{fi} ( b , a ) \vert}^{2} \frac{d a d b}{{a}^{2}} \leq {c}_{g}^{- 1} \int {\int }_{{𝒟}_{h}} {\vert {S}_{s} ( b , a ) \vert}^{2} \frac{d a d b}{{a}^{2}} \qquad Equation 14$$

In Equation 14, c_{g} is defined from the isometry property of the wavelet transform (see Equation 3). Eₛ_{_{fi}} is therefore a function of finite energy. Sₛ(b, a) and S_{f}_{ᵢ}(b, a) verify the reproducing equation (see Equation 8). In other words:

$$\int {\int }_{{𝒟}_{h}} {S}_{s} ( v , u ) ( v , u ; b , a ) \frac{d u d v}{{u}^{2}} = \int \int {S}_{fi} ( v , u ) 𝒩 ( v , u ; b , a ) \frac{d u d v}{{u}^{2}} = {S}_{fi} ( b , a ) \qquad Equation 15$$

These previous equations demonstrate that the filter 660 can apply an inverse continuous wavelet transform to the filtered wavelet coefficients to reconstruct a filtered version of a particular signal component fᵢ(t).

The use of a progressive and modulated Gaussian function as the analyzing wavelet (such as the progressive Morlet type wavelet) allows an explicit formula of the reproducing kernel to be obtained, as described above. Because this analyzing wavelet is a function that is well localized in the time-frequency space, the associated kernel is well localized in the plane of the transform. For example, to a first-order approximation, the reproducing kernel N(b₀, a₀; b, a) can be considered as a Dirac function for the couples {b₀, a₀}. This result demonstrates that if a Morlet's wavelet is used, the form of the mask is less important, as it can suffice to simply use the energy pattern of the signal that is to be filtered. If the mask includes some information far from the energy pattern of the signal, the contribution coming from this far information is likely to not affect the results of the filtering. Therefore it is possible for the filter 660 to filter the component i of the signal s(t) using the inverse continuous wavelet transforms as:

$${f}_{i} ( t ) = ℛ e [ {c}_{g}^{- 1} \int \int {S}_{fi} ( b , a ) g ( \frac{t - b}{a} ) \frac{d a d b}{{a}^{3 / 2}} ] \qquad Equation 16$$

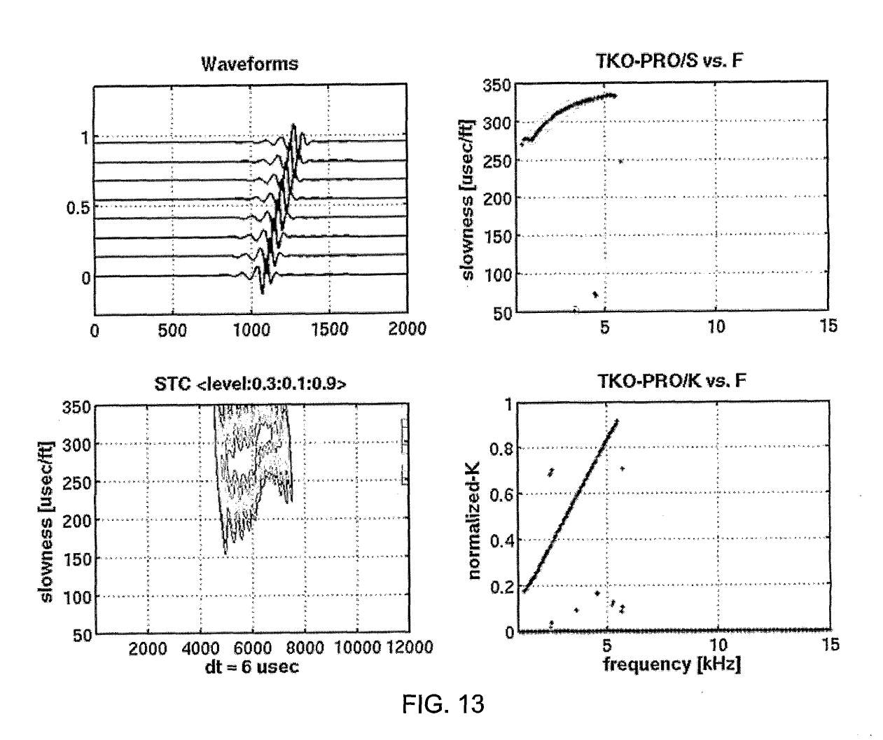

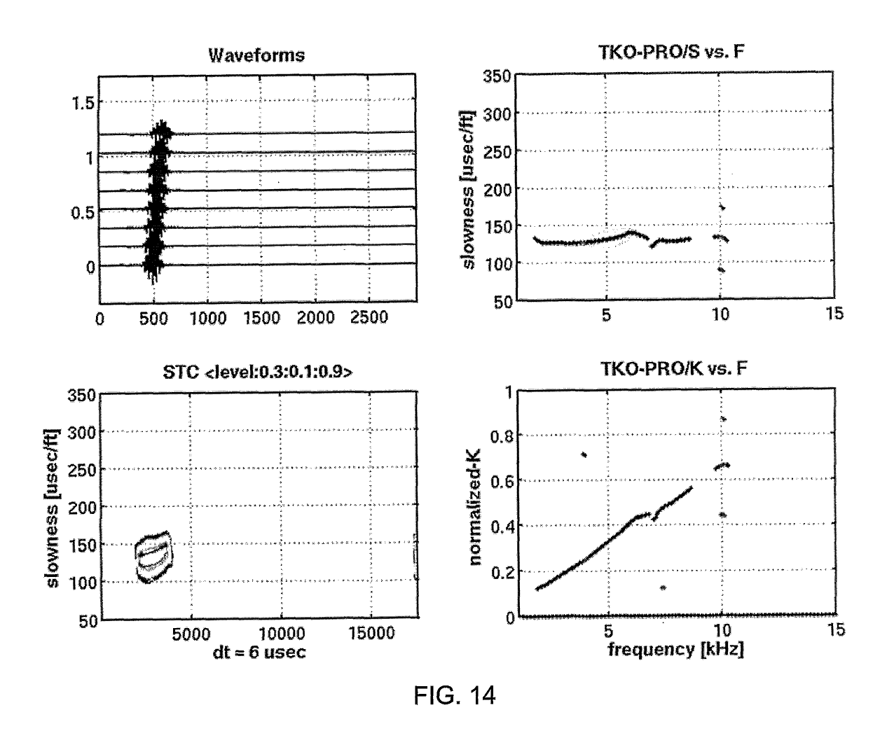

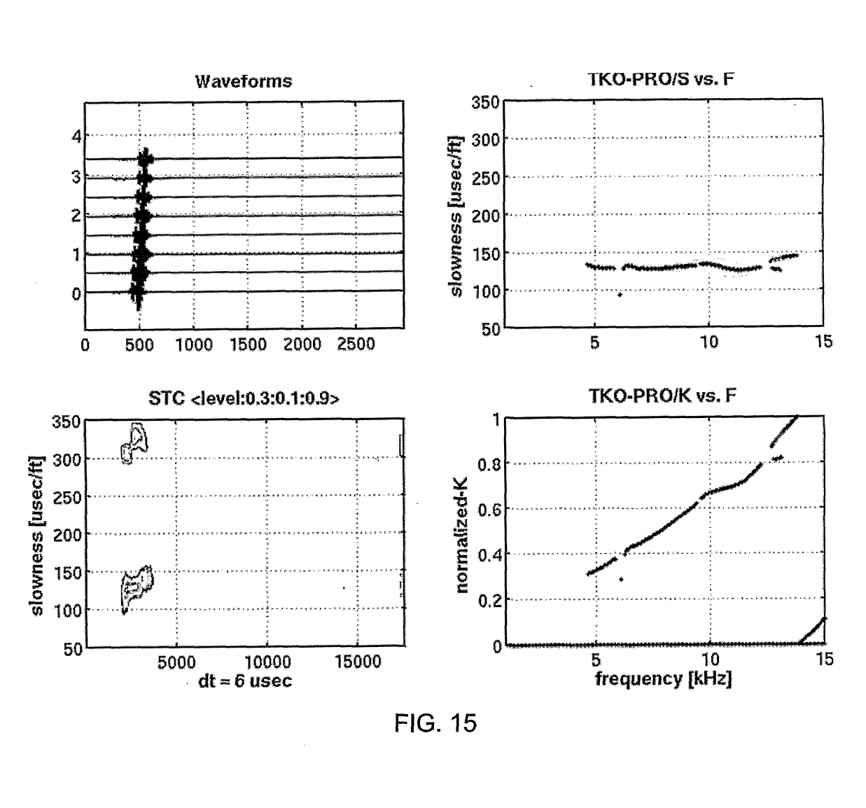

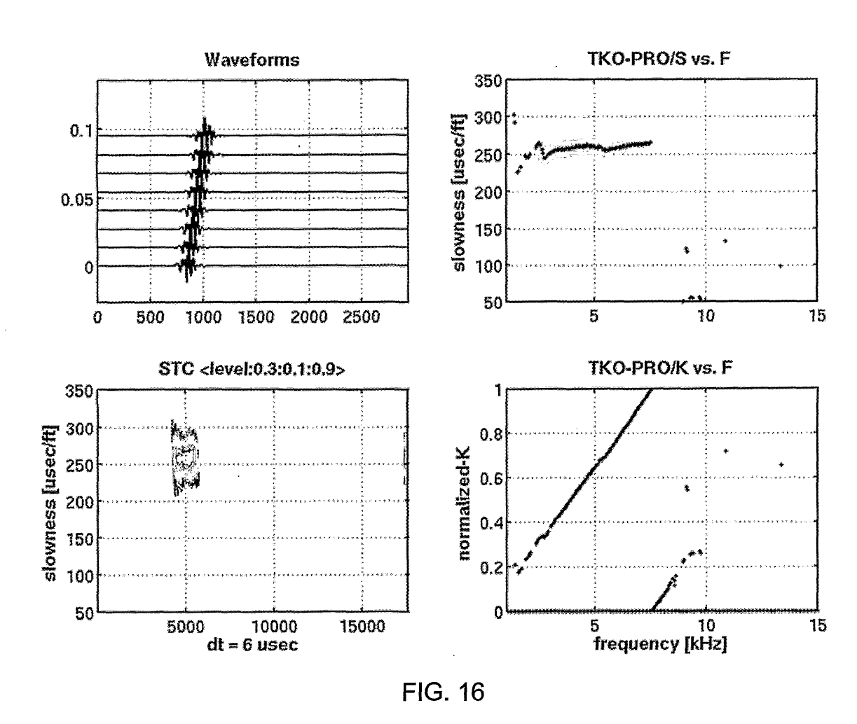

In Equation 16, C_{g} is the isometry constant and is dependent on only the wavelet, as described above. FIGS. 13-16 present the filtering of data shown in FIG. 10. In particular, FIG. 13 illustrates an example extraction of a dipole flexural mode using wavelet filtering as implemented by the filter 660. FIG. 14 illustrates an example extraction of a leaky compressional mode using wavelet filtering as implemented by the filter 660. FIG. 15 illustrates an example extraction of a compressional headwave using wavelet filtering as implemented by the filter 660. FIG. 16 illustrates an example extraction of a pseudo Rayleigh mode using wavelet filtering as implemented by the filter 660. As illustrated in FIGS. 13-16, the filter 660 is able to separate each of the components and facilitate the processing of their characteristic representations independently.

Although wavelet filtering as implemented by the filter 660 is described above in the context of filtering borehole acoustic data, the filter 660 can be used to filter other types of logged data.

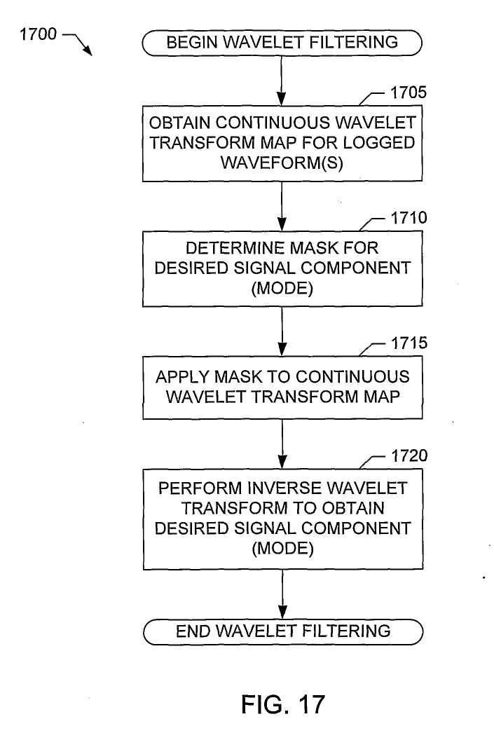

FIG. 17 illustrates an example process 1700 that can be used to implement the filter 660. The process 1700 begins at block 1705 at which the filter 660 obtains the CWT map as determined by the wavelet transformer 620 for logged waveforms 610 to be filtered (possibly after stacking as performed by the stacker 630). At block 1710, the filter 660 determines a mask to filter a desired component (mode) of the logged waveform(s). For example, the filter 660 can determine the mask automatically as described above based on a determined or preconfigured energy map for the desired signal component. At block 1715, the filter 660 applies the mask to the CWT map. The filtered CWT map can then be used in subsequent processing. Additionally or alternatively, at block 1720 the filter 660 performs an inverse wavelet transform on the filtered (i.e., masked) CWT map to yield a time-domain version of the desired signal component.

Example operation of the dispersion estimator 670 to perform dispersion curve estimation is now described. Further description of using wavelet transforms for dispersion curve estimation can be found in U.S. Patent Publication No. 2009/0067286, entitled “Dispersion Extraction for Acoustic Data using Time Frequency Analysis” and filed on Sep. 12, 2007, which is incorporated herein by reference in its entirety. In some examples, the dispersion estimator 670 estimates the group velocity, phase velocity and attenuation of propagating components of acoustic data collected by an array of sensors (e.g., such as the receiver array 400). The dispersion estimator 670 does not make specific assumptions about the data other than to assume that it consists of the superposition of one or more propagating components along with noise which do not significantly overlap in the time-frequency plane, although they could overlap in time or frequency domains separately. Each of these components could exhibit both attenuation and dispersion. U.S. Provisional Application Ser. No. 61/139,996, entitled “Automatic dispersion extraction of multiple time overlapped acoustic signals” and filed on Dec. 22, 2008, which is hereby incorporated by reference in its entirety, describes example techniques in which components can overlap in time and frequency, which could be used in more challenging environments instead of the single mode processing that can suffice in many cases and is further described below.

The dispersion estimator 670 performs dispersion curve estimation based on the use of the complex continuous wavelet transform described above. To develop an example operation of the dispersion estimator 670, consider a single propagating mode as received by a pair of sensors on an array (e.g., such as the receiver array 400). The Fourier transform of the signal received at a second (lth) sensor in terms of that at a first (jth) sensor can be written mathematically as follows:

ŝₗ(f)=ŝⱼ(f)e^{-2iπδ}^{ₗⱼ}^{k(f)}^{ₑ}^{-δ}^{ₗⱼ}^{A(f)}, Equation 17

In Equation 17, k(f) and A(f) are, respectively, the wavenumber and the attenuation as functions of frequency and denotes the spacing between the l^{th} and j^{th} sensors. In some examples, an objective is to extract the wavenumber and the attenuation to be able to derive the group and phase velocity. This problem can be solved by taking a local linear Taylor expansion of the wavenumber k(f) and attenuation A(f), which may be expressed as:

k(f)≈k(fₐ)+(f−fₐ)k′(fₐ)+o(|f−fₐ|)

A(f)≈A(fₐ)+o(|f−fₐ|) Equation 18

where the expansion is around the central frequency

$${f}_{a} = \frac{{ω}_{0}}{2 π a}$$

at the scale a, where ω₀ is the central frequency of the mother wavelet.

The use of the approximations in Equation 18 is supported by numerical studies on dispersion curves indicating that it suffices to capture the local variations of the wavenumber and attenuation, especially since physical considerations impose smoothness on the latter. Using this local linear expansion and after some simplification, the relation between the CWT coefficients for two receivers of the receiver array 400 is given by Equation 19:

Sₗ(a,t)=e^{-δ}^{ₗ}^{A(f}^{ₐ}⁾×e^{-iδ}^{ₗ}^{2πφ}^{ₐ}×Sₗ_{₀}(a,t−δₗs_{g}) Equation 19

In Equation 19, φₐ□fₐ[k(fₐ)/fₐ−k′(fₐ)]=fₐ[s_{φ}(fₐ)−s_{g}(fₐ)] is a phase factor dependent on the difference of the phase and group slowness, l₀ indexes the reference sensor with the distance to it of the l^{th} sensor denoted by δₗ, and the time shift parameter b is represented as time, t. In other words, the wavelet coefficients are treated as waveforms in time.

Equation 19 shows that at each scale a, the CWT coefficients at the l^{th} sensor are time shifted with respect to those at the l₀^{th} sensor by an amount given by the group slowness and inter-sensor distance, and multiplied by a factor whose magnitude is dependent on the attenuation and whose phase depends on the difference of the phase and group slowness. Therefore, given the coefficients at a particular scale, a, corresponding to the frequency, fₐ, the dispersion estimator 670, in some examples, estimates three quantities, namely, the attenuation, the phase slowness and the time shift given by the group slowness at the frequency fₐ corresponding to the scale a being processed. The dispersion estimator 670 repeats this processing for other scales (frequencies) of interest to obtain desired dispersion curve estimates.

Two example methods are described herein to estimate attenuation, phase slowness and group slowness from CWT maps of received waveforms.

Method 1: Extracting the Group Slowness from the Modulus Maxima of the Wavelet Transform

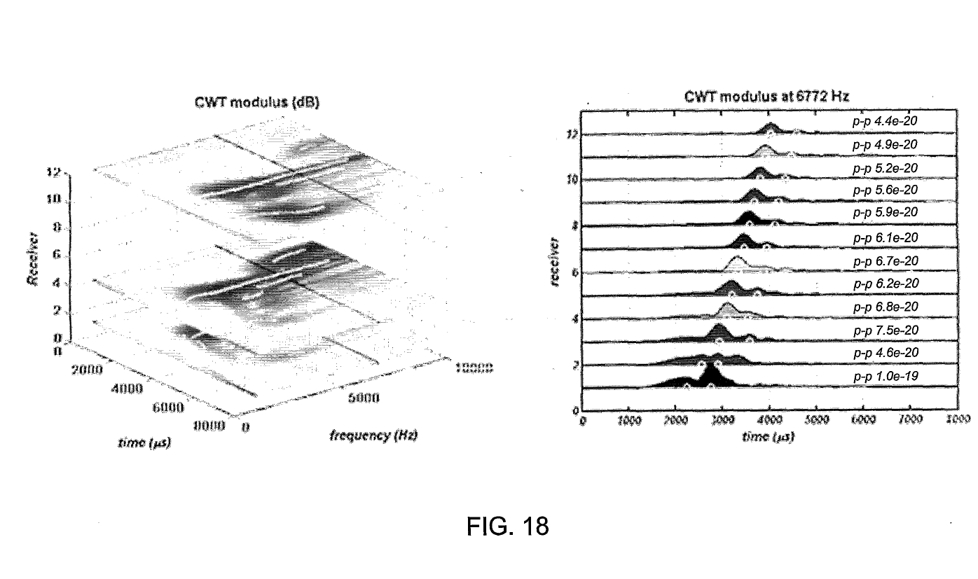

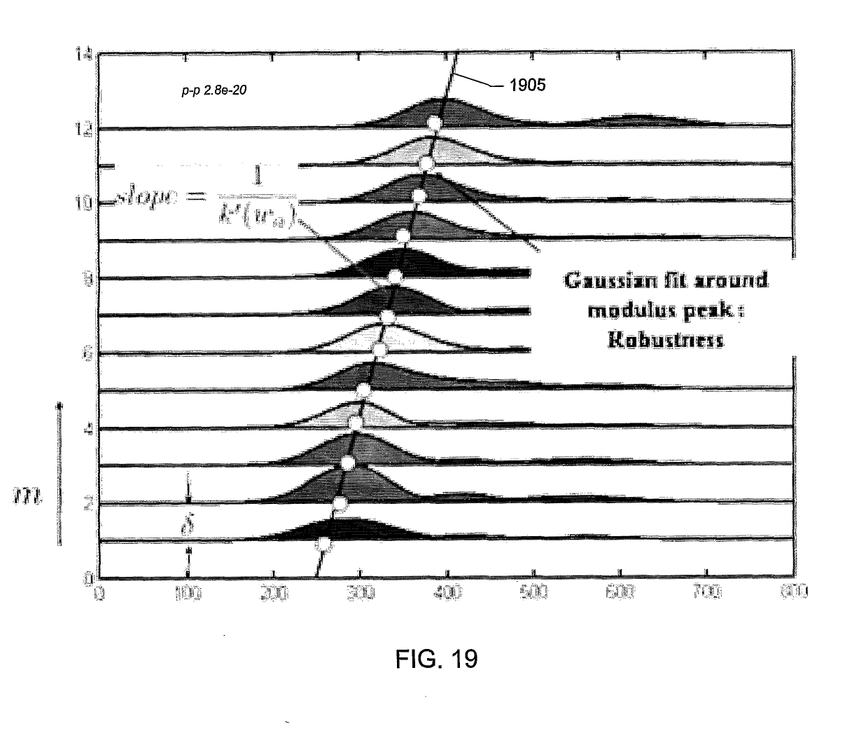

The group slowness represents the velocity with which a wave's envelope (shape of the amplitude) and energy propagates through space. For dispersive waves, the group velocity is a function of the frequency. As the wavelet transformation conserves the energy of the signal, it is possible to estimate the group velocity as a function of frequency directly in the wavelet domain. In particular U.S. Patent Publication No. 2009/0067286, mentioned above, describes that the location of the maximum peak of the magnitude of the wavelet transform at scale a provides the arrival time of the propagating wave with a group velocity s_{g} at the corresponding frequency. Therefore, to extract the group slowness across the array of sensors, a line can be fitted in the least squares sense to the modulus peak locations at the sensors for each scale and the slope of the fitted line can be used to obtain the group slowness estimate at the corresponding center frequency, fₐ. The peak location estimates can be corrected via exponential quadratic interpolation across time. In some examples, the exponential quadratic interpolation is chosen because the envelope of the reproducing kernel is a quadratic exponential in ‘b’ (see e.g., Grossmann, A., and Morlet, J, 1984 Decomposition of Hardy functions into square integrable wavelets of constant shape. SIAM Journal of Mathematical Analysis, Vol. 15, pp. 723-736). FIGS. 18-19 illustrate an example method that can be used by the dispersion estimator 670 to extract the group slowness from the modulus of the wavelet transform of the recorded waveforms. In particular, FIG. 18 illustrates a collection of CWT maps for an array of waveforms (e.g., obtained via the receiver array 400) and a collection of the coefficients at a particular frequency (scale) in an array for the dispersion processing at that frequency. FIG. 19 also shows computation of group slowness at one scale (e.g., frequency). The group slowness is given by the slope of the fitted line 1905 to the corrected locations of the modulus peaks. The latter are obtained as shown by fitting a Gaussian around the modulus peaks.

From Group to Phase Slowness and Attenuation

Given the group slowness, the dispersion estimator 670 can then extract the phase slowness and attenuation by using the relationship given by Equation 19. To do so, the dispersion estimator 670 first applies a time shift, given by δₗs_{g}(fₐ), using the estimates of the group slowness obtained above, to the wavelet coefficients, Sₗ(a,t) at each frequency. Then, the dispersion estimator 670 obtains a rank one subspace model for the shifted coefficients, which is given by Equation 20:

$$\begin{matrix}{Y}_{a} {=}^{d} [ \begin{matrix}{S}_{1} ( a , {t}^{′} + {δ}_{1} {s}_{g} ) \\ {S}_{2} ( a , {t}^{′} + {δ}_{2} {s}_{g} ) \\ ⋮ \\ {S}_{L} ( a , {t}^{′} + {δ}_{M} {s}_{g} )\end{matrix} ] \\ = [ \begin{matrix}{e}^{- δ ( α + iϕ ) ( 1 - {l}_{0} )} \\ {e}^{- δ ( α + iϕ ) ( 2 - {l}_{0} )} \\ ⋮ \\ {e}^{- δ ( α + iϕ ) ( L - {l}_{0} )}\end{matrix} ] {S}_{{l}_{0}} ( a , {t}^{′} ) + N \\ {=}^{d} {US}_{{l}_{0}} ( a , {t}^{′} ) + N\end{matrix} \qquad Equation 20$$

In Equation 20, a uniform linear array has been assumed with 8 as the common inter-sensor spacing between adjacent sensors. Additionally, in Equation 20, Yₐ and U are defined appropriately as shown, and α=A(fₐ), with the subscript on φ having been dropped. In Equation 20, t′ refers to the modulus peak location (and indices in a neighborhood thereof) and N refers to the noise. Given the further quantities defined of Equation 21:

$${Y}_{a , 1} = [ \begin{matrix}{Y}_{a} ( 1 ) \\ {Y}_{a} ( 2 ) \\ ⋮ \\ {Y}_{a} ( L - 1 )\end{matrix} ] , \\ {Y}_{a , 2} = [ \begin{matrix}{Y}_{a} ( 2 ) \\ {Y}_{a} ( 3 ) \\ ⋮ \\ {Y}_{a} ( L )\end{matrix} ) \qquad Equation 21$$

the dispersion estimator 670 can compute the quantities of Equation 22:

Rᵢⱼ=ΣY_{a,i}*⊙Y_{a,j} Equation 22

for i, j=1,2. In Equation 22, the symbol (•)* denotes the complex conjugate, the symbol ⊙ implies the element-by-element product of the matrices Y_{a,i} and Y_{a,j}, and the symbol Σₒ indicates a sum taken over all the elements of the product matrix so obtained. Because R₁₂ and R₂₁ are complex conjugates, only one of those quantities needs to be computed in practice.

The resulting estimates of α and φ determined by the dispersion estimator 670 are given by Equation 23:

$${α}^{⋒} = - log ( \frac{\sqrt{{( {R}_{11} - {R}_{22} )}^{2} + 4 {‖ {R}_{12} ‖}^{2}} - {R}_{11} + {R}_{22}}{2 ‖ {R}_{12} ‖} ) / δ \\ {ϕ}^{⋒} = - ∠ ( {R}_{12} ) / δ \qquad Equation 23$$

In Equation 23, ∠(R₁₂) denotes the complex phase of R₁₂.

As explained above, these estimates can now be used to generate estimates for the phase slowness and attenuation at the frequency corresponding to the scale a being processed. Repeating this for all scales (frequencies) of interest, the dispersion estimator 670 can obtain desired dispersion curve estimates.

Method 2: The Exponential Projected Radon Transform (EPRT)

A second example method that can be implemented by the dispersion estimator 670 is also based on Equation 19. Recall that there are three quantities to estimate, namely, the attenuation factor, the phase factor and the time shift given by the group slowness. A new, modified version of the Radon transform, called the exponential projected Radon transform (EPRT), is introduced to handle the additional phase and attenuation factors by estimating them as per Equation 23 and using the estimates to project onto a rank one subspace U as defined in Equation 20. This projection is shown in Equation 24:

$$\begin{matrix}{p}_{U} = \frac{1}{\sqrt{{U}^{H} U}} {U}^{H} \\ = \frac{1}{\sqrt{{\sum }_{l} {e}^{- 2 {α}^{⋒} δ ( l - {l}_{0} )}}} {U}^{H} \\ = {( {e}^{- {α}^{⋒} δ ( 2 {l}_{0} - 1 - L )} \frac{sinh ( {α}^{⋒} δ )}{sinh ( L {α}^{⋒} δ )} )}^{1 / 2} {U}^{H}\end{matrix} \qquad Equation 24$$

In Equation 24, (•)^{H} denotes the Hermitian or complex conjugate transpose. Applying this projection on the wavelet coefficients computed on the array data at a particular scale a for a set of times and moveouts, the analogous form for the modified Radon transform is given by Equation 25:

$${R}_{a} ( t , p ; {α}^{⋒} , {ϕ}^{⋒} ) = {e}^{- {α}^{⋒} ( 2 {l}_{0} + 1 - L )} \frac{sinh ( {α}^{⋒} δ )}{sinh ( L {α}^{⋒} δ )} \times {\int }_{t}^{t + T} w {\vert {\sum }_{l = 1}^{L} {e}^{- ( {α}^{⋒} - i {ϕ}^{⋒} ) δ ( l - {l}_{0} )} {s}_{l} ( a , t + p ( l - {l}_{0} ) δ ) \vert}^{2} d t \qquad Equation 25$$

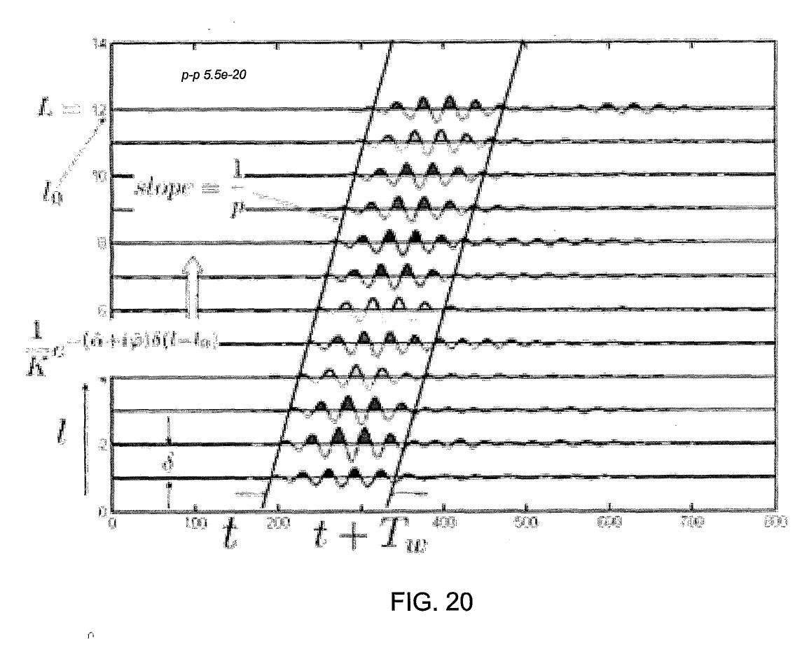

In some examples, the dispersion estimator 670 operates on energy and, therefore, squares the projected quantities and further integrates this energy in a window positioned according to the parameter t. The quantities \hat{α} and \hat{φ} can be estimated for each t and p and, therefore, are functions of the latter. This operation is an operation of the Exponential Projected Radon Transform (EPRT) on the complex coefficients of the CWT of array data at a particular scale a, as is illustrated in FIG. 20. Referring to FIG. 20, for each moveout p and time location t, the array of coefficients corresponding to the aforesaid time t and moveout p are collected and used to estimate the attenuation (\acute{α}) and phase factors (φ). The latter are used to implement a generalization of the slant stack or Radon transform, wherein a projection onto a subspace comprising the estimated phase and attenuation factors multiplied by receiver position (δ) is applied. K is a normalizing constant. Operationally, that means that these factors are applied to the coefficients at each receiver before summation. An associated semblance quantity is also computed as indicated in Equation 26. A window of width T_{W}, dependent on the scale a, is used to stabilize the semblance as well as the phase and attenuation estimates.

For example, a corresponding semblance quantity for each scale can be computed using Equation 26:

$${ρ}_{a} ( t , p ; {α}^{⋒} , {ϕ}^{⋒} ) = {e}^{- {α}^{⋒} ( 2 {l}_{0} + 1 - L )} \frac{sinh ( {α}^{⋒} δ )}{sinh ( L {α}^{⋒} δ )} \times \frac{{{\int }_{t}^{t + T} w \vert {\sum }_{l = 1}^{L} {e}^{- ( {α}^{⋒} - i {ϕ}^{⋒} ) δ ( l - {l}_{0} )} {s}_{l} ( a , t + p ( l - {l}_{0} ) δ ) \vert}^{2} d t}{{\int }_{t}^{t + {T}_{w}} {\sum }_{l = 1}^{L} {\vert {S}_{l} ( a , t + p ( l - {l}_{0} ) δ ) \vert}^{2} d t} \qquad Equation 26$$

In Equation 26, when \hat{α},\hat{φ}=0, the expression for the non-dispersive case is obtained. Maps on the (t, p) plane analogous to the Radon transform and semblance, where each point on the map is computed using the corresponding estimated quantities \hat{α} and \hat{φ} for the projection, are obtained accordingly. These maps are referred to as the Exponential Projected Radon Transform (EPRT) and the EPRT semblance.

The peaks of the EPRT map give information about the time localization and group slowness of the propagating components at the scale being analyzed, whereas the corresponding estimated phase and attenuation factors can be used to extract the corresponding phase slowness and attenuation. This extraction and possible refinements are discussed further in the next section.

Estimating Slowness and Attenuation

Based on the analysis of the EPRT for a single mode, the semblance is maximized when Equation 27 is satisfied:

$${α}^{⋒} = A ( {f}_{a} ) + {A}^{′} ( {f}_{a} ) {f}_{δ} \\ \hat{p} = {s}_{g} ( {f}_{a} ) + {s}_{g}^{/} ( {f}_{δ} + \frac{{Γ}_{f}^{3}}{2 {Δ}_{f}^{2}} ) \\ {ϕ}^{⋒} = 2 πδ \{ {s}_{φ} ( {f}_{a} ) {f}_{a} - \hat{p} {f}_{a} + \frac{{s}_{g}^{/}}{2} ( {Δ}_{f}^{2} - {f}_{δ}^{2} - \frac{{Γ}_{f}^{3} {f}_{δ}}{{Δ}_{f}^{2}} ) \} \qquad Equation 27$$

In Equation 27, the following spectral moments have been defined using Equation 28:

$${f}_{δ} = \frac{\int {\vert \tilde{X} ( a , f ) \vert}^{2} ( f - {f}_{a} ) d f}{\int {\vert \tilde{X} ( a , f ) \vert}^{2} d f} , \\ {f}_{c} = {f}_{a} + {f}_{δ} \\ {Δ}_{f}^{2} = \frac{\int {\vert \tilde{X} ( a , f ) \vert}^{2} {( f - {f}_{c} )}^{2} d f}{\int {\vert \tilde{X} ( a , f ) \vert}^{2} d f} , \\ {Γ}_{f}^{3} = \frac{\int {\vert \tilde{X} ( a , f ) \vert}^{2} {( f - {f}_{c} )}^{3} d f}{\int {\vert \tilde{X} ( a , f ) \vert}^{2} d f} \qquad Equation 28$$

Equation 28 represents, respectively, the difference between the spectrally weighted mean frequency, f_{c}, and the center frequency fₐ; the spectrum spread (variance) around the spectral mean frequency; and the “skew” of the spectrum around the mean frequency. In Equation 28, \tilde{X}(a, f) represents the spectrum of the mode of interest as captured in the window. The parameters \hat{α} and \hat{φ} are estimated for each choice of p (and window position t) using Equation 23.

When the spectrum of the mode of interest is relatively flat over the support of the analyzing wavelet at the scale (frequency) being processed, or when the derivative of the group slowness (attenuation) is small in the sense as given by Equation 29:

s′_{g}Δ_{f}□s_{g},s_{φ}, A′(fₐ)Δ_{f}□A(fₐ) Equation 29

the estimates for attenuation, group slowness and phase slowness can be approximated by Equation 30:

$$\hat{A} ( {f}_{a} ) ← {α}^{⋒} \approx {A}_{0} \\ {\hat{s}}_{g} ← \hat{p} \approx {s}_{g} \\ \begin{matrix}{\hat{s}}_{φ} ← \hat{p} + \frac{{ϕ}^{⋒}}{2 π {f}_{a} δ} = {s}_{φ} ( {f}_{a} ) + \frac{{s}_{g}^{/}}{2 {f}_{a}} ( {Δ}_{f}^{2} - {f}_{δ}^{2} - \frac{{Γ}_{f}^{3} {f}_{δ}}{{Δ}_{f}^{2}} ) \\ \approx {s}_{φ} ( {f}_{a} )\end{matrix} \qquad Equation 30$$

In some examples, the dispersion estimator 670 can implement Equation 30 as the standard estimates for attenuation, group slowness and phase slowness. In some examples, a bias correction incorporating further refinements based on Equation 28 can also be implemented for greater accuracy when the assumptions of Equation 29 do not hold.

In some examples, the CWT coefficients corresponding to the mode of interest are determined by tracking the peaks on the modulus maxima and labelling them with data assocication, as described in U.S. Patent Publication No. 2009/0067286, mentioned above.

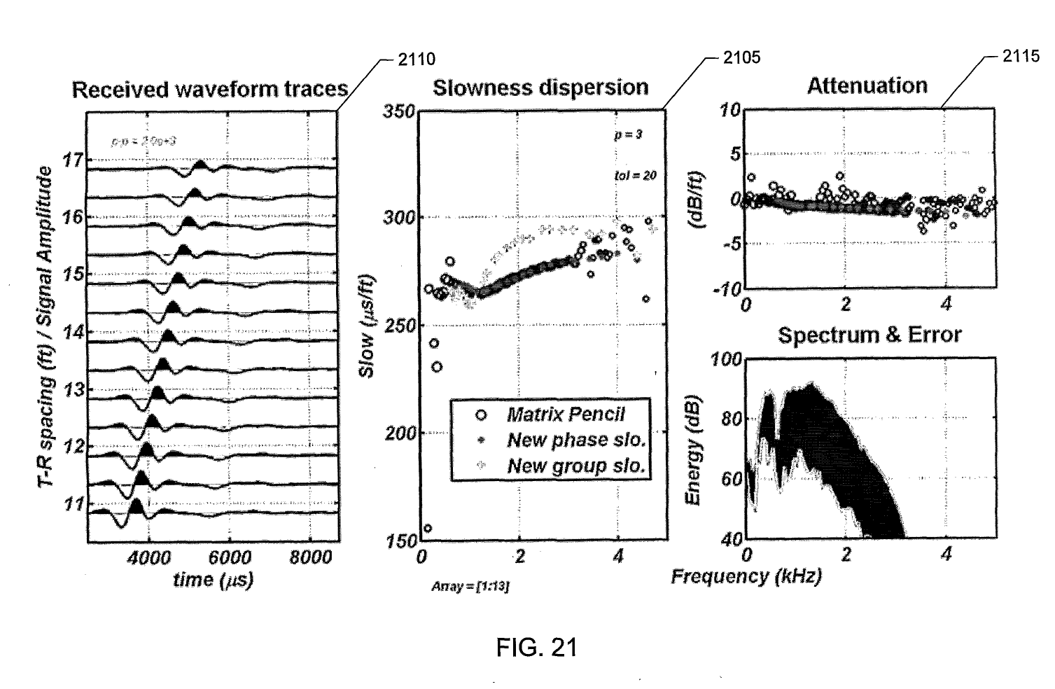

FIG. 21 illustrates an example dispersion extraction result (see graph 2105) from waveforms (see graph 2110). Group and phase slowness are illustrated in FIG. 21, along with the corresponding dispersion extraction obtained using a matrix pencil method. Graph 2105 demonstrates that there is a good match between the extracted dispersion curve and the computed ones. A graph 2115 illustrates computed attenuation extracted simultaneously with the dispersion curves.

The dispersion estimator 670 performs extraction of dispersion curves from wavelet maps, whereas the filter 666 performs data filtering using the reconstruction properties of the continuous wavelet transform. In some examples, the processing performed by both the filter 660 and the dispersion estimator 670 is combined to efficiently filter signals of interest.

For example, as mentioned above, image processing techniques can be used to detect components of interests across the array prior to filtering them. Even though this approach is effective, it can have the disadvantage of being too computationally expensive for a well site implementation. In such cases, the information from the extracted dispersion curves can be to reconstruct waveforms in a computationally efficient manner.

As described above, the dispersion estimator 670 performs its processing in the wavelet domain. During this processing, wavelet coefficients related to the mode of interest are selected out of the entire wavelet map coefficients. This means, in practice, that at the end of the process a dispersion curve is obtained together with the wavelet coefficients linked to this dispersion (i.e., that have been used to perform the computation). Therefore it is straightforward to apply the continuous wavelet reconstruction formula to these coefficients to get the temporal array waveforms linked to the extracted dispersion. This approach allows the extraction of the signal of interest in an automatic and unsupervised manner while conserving computation time which makes this approach a good candidate for well site implementation.

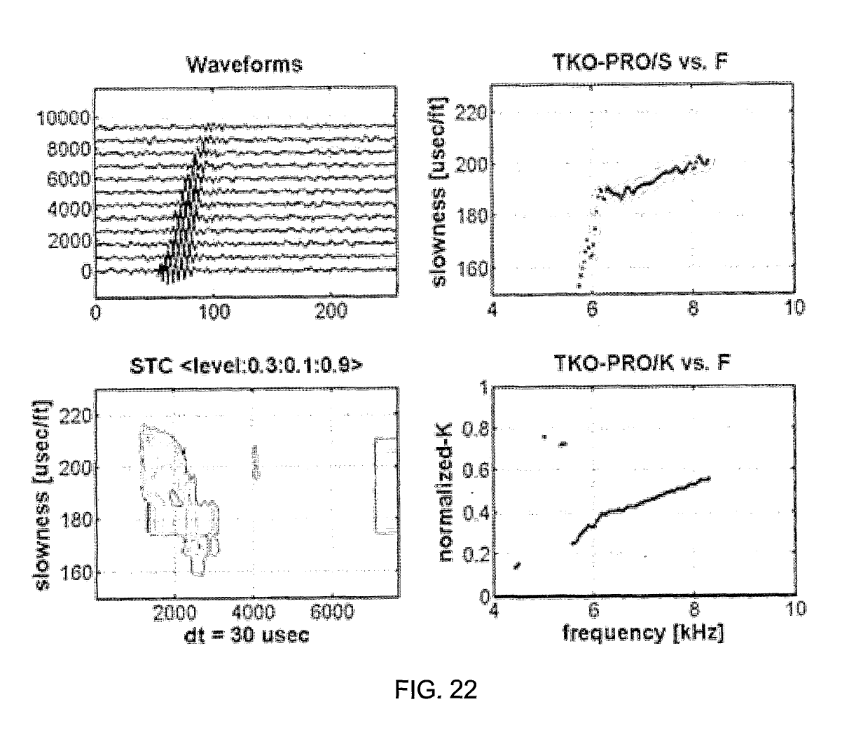

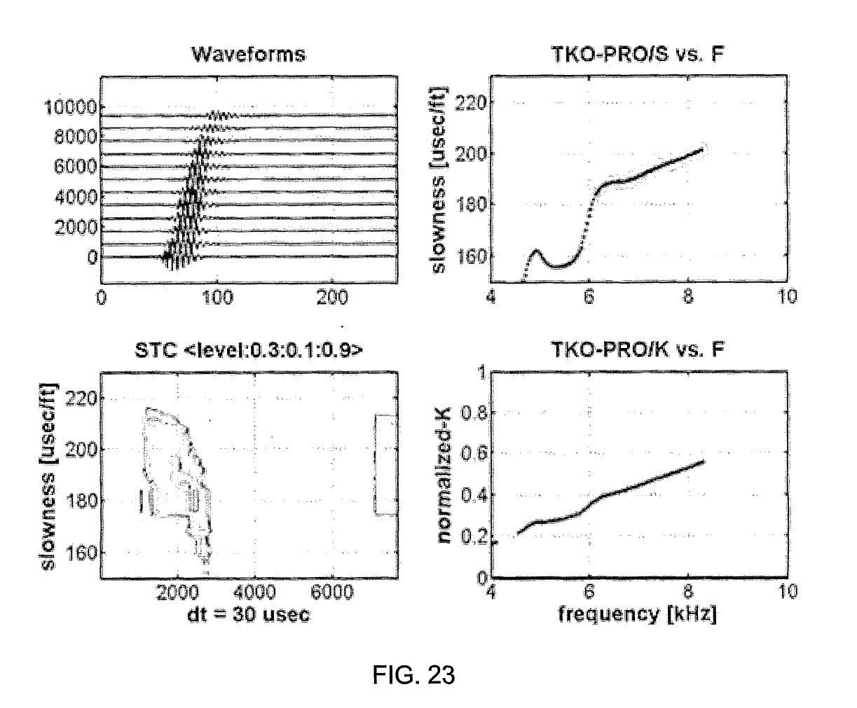

FIG. 22 illustrates results for real quadrupole data in presence of noise. Note how the dispersion curves oscillate due to the effect of noise. FIG. 23 illustrates example results after combining dispersion extraction and wavelet filtering. Note how the waveforms are clean and the dispersion curve smooth in FIG. 23 relative to FIG. 22.

Example operation of the dispersion curve inverter 680 to estimate formation parameters, such as formation shear slowness, from dispersion curves determined by the dispersion estimator 670 are now described. For example, and as described in greater detail below, the dispersion curve inverter 680 can estimate formation shear slowness and borehole fluid compressional slowness from borehole acoustic data. Although operation of the dispersion curve inverter 680 is described in the context of processing logging while drilling data, the example methods and apparatus described herein are not limited thereto and could be applied to any type of acoustic data.

In some examples, the dispersion curve inverter 680 performs parametric inversion of guided wave modal dispersion curves to determine values of the formation parameters defining the dispersion curves. The guidance condition or characteristic equation for a two-dimensional waveguide structure invariant in the z direction and described by a parameter vector x̅ containing geometrical and material constants can be written as:

D(k_{z},ω, x̅)=0 Equation 31

Here D represents the determinant of the system matrix L of the homogeneous linear system of equations that follows from matching the appropriate boundary conditions, k_{z} is the wavenumber in the direction of propagation, and ω is the angular frequency considered.

For a fixed parameter vector x̅, D can be treated as a function of two independent complex variables, k_{z} and ω. When seeking steady-state solutions to problems involving a time-harmonic excitation, ω will be real. When computing transients utilizing a temporal Laplace transform, both k_{z} and ω are in general complex, depending on the specific paths of integration chosen. Due to the unique roles of time and space in a mixed initial boundary value problem, k_{z} and ω are not interchangeable and no simple conversion exists between roots of Equation 31 found in the complex k_{z} domain (for a fixed ω) and the complex ω domain (for a fixed k_{z}).

For open waveguides that allow radiation of energy away from the vicinity of the waveguide into the background medium (which is homogeneous only in some situations) the complex ω and k_{z} domains are multi-sheeted Riemann surfaces (i.e., collections of complex planes connected across branch cuts). Except for isolated singularities (branch points and poles) D is analytic on these surfaces.

For a smooth curve Ω in the ω domain (typically but not necessarily the positive real axis), the roots of Equation 31 for some ω=ω₀εΩ constitute a set of modes. Choosing a particular mode by selecting one of the roots, the dispersion relation k_{z}(ω, x̅) for this mode (with respect to Ω) is obtained by tracing the locus of the root in the k_{z} domain as ω moves away from ω₀ and along Ω. In some examples, the dispersion curve {k_{z}(ω, x̅): ωεΩ} is also required to be smooth to avoid a mix-up with other modes at possible points of degeneracy where different dispersion curves intersect.

This notion of dispersion supports a numerical method for computing modal dispersion curves practically. Starting from coₒ, one or two (depending if ωₒ is an endpoint of Ω or not) sequences of sufficiently close frequencies on Ω are chosen. By inspecting, for example, |D(k_{z}, ω, x̅)| in the k_{z} domain, a mode is selected and an initial guess for k_{z}(ω₀, x̅) obtained. In identifying local minima of |D| as zeros, the minimum principle in complex analysis ensures that a local minimum of |D| embedded into a neighborhood, for which it is the absolute minimum and throughout which D is analytic, must be a zero.

Formally, the minimum principle states: If f is a non-constant analytic function on a bounded open set G and is continuous on the closure of G, then either f has a zero in G or |f| assumes its minimum value on the boundary of G.

Using the initial guess, k_{z}(ω₀, x̅) is determined by finding the zero of D using, for example, the complex Newton-Raphson method. Subsequently, stepping along Ω away from ω₀, samples of k_{z}(ω, x̅) are computed for each ω, using the k_{z} found at the previous frequency as initial guess. Thus the dispersion curve is obtained by this mode tracking procedure.

The dispersion curve inverter 680 resolves the inverse problem involving estimation of the N unknown elements of x̅ from bandlimited, possibly noisy samples of one or more dispersion curves. The number of parameters N to be determined can be less than the dimension of x̅ in case some of the elements of x̅ were, for example, derived from other measurements.

Given M measured pairs (ωᵢ,k_{zi}) that satisfy:

k_{zi}=k_{z}(ωᵢ, x̅)+nᵢ, i=1, 2, . . . , M Equation 32

where n̅=[nᵢ] represents the noise in the data and, as in the case of multi-mode data, where the k_{z}(ωᵢ, x̅) may belong to different modes, one possible formulation of the inverse problem aims at minimizing the cost function of Equation 33:

$${‖ {\overline{e}}_{0} ( {\overline{x}}_{0} ) ‖}^{2} = {\sum }_{i = 1}^{M} {\vert {k}_{z} ( {ω}_{i} , \overline{x} ) - {k}_{zi} \vert}^{2} \qquad Equation 33$$

A drawback of this approach is that each single evaluation of Equation 33 for varying x̅, in whatever optimization method is employed, requires the M roots k_{z}(ωᵢ, x̅), which can be determined exactly only by iteration. These iterations may be avoided by pre-computing a look-up table of k_{z} for all possible x̅, ω, and modes, which itself might be an extensive computational task, but then the necessary interpolations during the inversion would preclude an exact answer even in the case of noise-free data. Furthermore, the implicit mode identification problem, (i.e., relating each k_{zi} to the correct dispersion curves) may complicate the situation. If k_{zi} is used as initial guess when iteratively computing k_{z}(ωᵢ, x̅), the wrong mode can be picked up accidentally.

The above difficulties can be avoided by solving the inverse problem without resorting to the dispersion curves k_{z}(ω, x̅) explicitly. With this in mind, in some examples the dispersion curve inverter 680 performs minimization of the “guidance mismatch” given by Equation 34:

$${‖ \overline{e} ( {\overline{x}}_{0} ) ‖}^{2} = {\sum }_{i = 1}^{M} {\vert D ( {k}_{zi} , {ω}_{i} , \overline{x} ) \vert}^{2} \qquad Equation 34$$

The cost function Equation 33 for the case of noise-free data, can be made zero, similar to Equation 34. For noisy data, the least-squares problem can be solved by applying the Gauss-Newton method. The partial derivatives in the Jacobian are typically replaced by finite differences unless the structure considered is simple enough so that the differentiations can be carried out analytically. It is seen that, whereas Equation 33 is of the same form as in curve fitting problems, in Equation 34 the data k_{zi} and, thus, the noise n̅ influence ē in a nonlinear fashion.

An example method that can be implemented by the dispersion curve inverter 680 performs 1D inversion of modal dispersion curves to determine formation shear slowness. In this single-parameter inversion case, only one data input would be sufficient in cases where there is no noise. However, in practice, there are various types of noise present in the data. Therefore dispersion curve inverter 680 inverts multiple data inputs simultaneously (i.e. M>1).

An example inversion method has been implemented in MATLAB™. The minimization function used is called “lsqnonlin” with a “Gauss-Newton” algorithm. The Jacobian is calculated using finite difference.

To avoid local minimum and improve computation speed, a searching region is initialized for inverting formation shear slowness. In some examples, the upper bound is chosen as a maximum of the phase slowness (e.g., max(kᵢ/ωᵢ)), whereas the lower bound is set to 1.45 (or some other coefficient value) times the formation compressional slowness (e.g. 1.45×DTc). In some examples, the initial estimate used to start the inversion process is the middle point of the search interval so defined. The choice of the coefficient 1.45 for use in setting the search region's upper bound is based on the relation between Poisson's ratio v and compressional-shear velocity ratio vₚ/vₛ as given by Equation 35:

$$v = ρ {v}_{s}^{2} \frac{[ {( {v}_{p} / {v}_{s} )}^{2} - 2 ]}{2 [ {( {v}_{p} / {v}_{s} )}^{2} - 1 ]} \qquad Equation 35$$

To obtain a positive v, vₚ/vₛ has to be greater than \sqrt{2}. Therefore, in some examples 1.45×DTc is chosen as the lower bound for potential shear slowness (DTs) values.

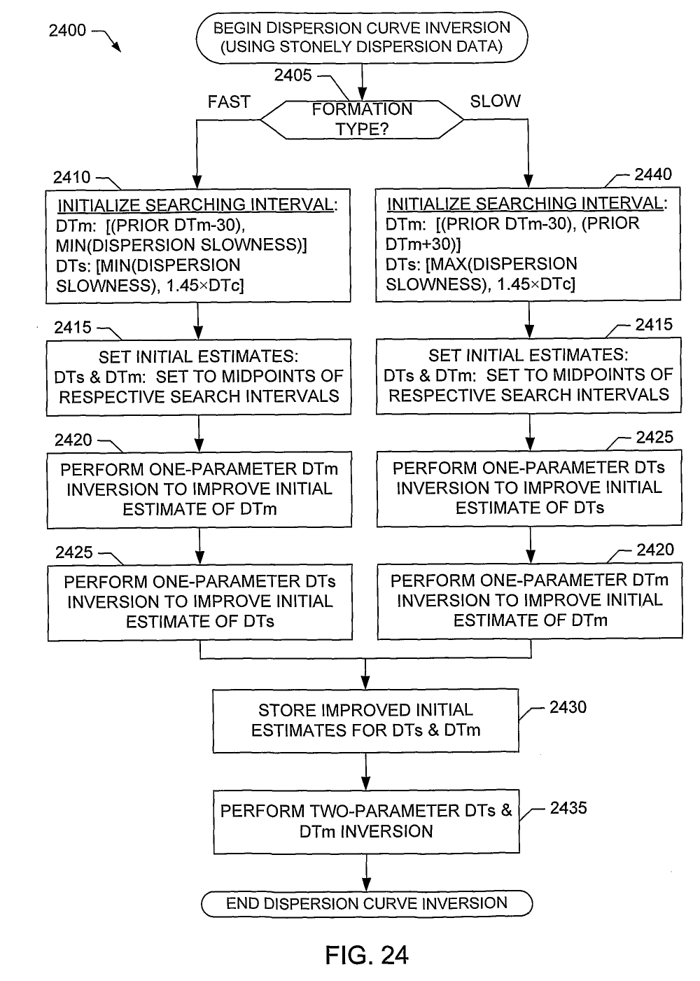

An example method 2400 that can be implemented by the dispersion curve inverter 680 to perform 2D inversion of modal dispersion curves to determine formation shear slowness and mud slowness simultaneously is illustrated in FIG. 24. In particular, the example method 2400 of FIG. 24 performs Stoneley dispersion curve inversion. Similar to the single-parameter inversion method described above, data inputs at multiple frequencies are also used for this two-parameter inversion, and the minimization function in MATLAB™ is also lsqnonlin as in the single-parameter inversion described above.

The example method 2400 of FIG. 24 performs different processing chains depending on the formation type (e.g., fast or slow formation). Both processing chains integrate 1D parameter inversion and 2D parameter inversion. In particular, results of the single-parameter (1D) inversion are used to provide initial estimates for the two-parameter (2D) inversion. Assuming a fast formation (block 2405), the method 2400 initializes the search region (search band) for inverting shear slowness as described above in the example single parameter inversion (block 2410). However, a different search region is initialized for mud slowness inversion (block 2410). For example, because a prior estimate for mud slowness can usually be obtained based on the prior knowledge of drilling mud, the lower bound for mud slowness is set at block 2410 as a prior estimate minus 30 μs/ft. However, the upper bound depends on the mode considered (e.g., dipole, Stoneley, quadrupole, etc.) and the formation. For example, when estimating the shear from Stoneley dispersion for a fast formation (as in the illustrated example), the upper bound of the search region for mud slowness is set as 0.98 times the minimum of the phase slowness.

After setting the initial shear slowness and mud slowness estimates to be the midpoints of their respective search regions (block 2415), the method 2400 then performs a 1D inversion which inverts for mud slowness using the initial estimate for formation shear slowness (block 2420). Then, with the inverted mud slowness, the method 2400 again performs 1D inversion to invert for the formation shear slowness using the inverted mud slowness (block 2425). Such an approach is expected to improve the initial shear estimate.

After the 1D inversion processing at block 2420 and 2425 is performed to determine initial inverted shear slowness and mud slowness values, these values are stored (block 2430) and dispersion curve inversion using the two parameters inversion using the initial estimates computed previously is performed (block 2435). Final mud and shear slowness values are then output by the method 2400.

The method 2400 performs slightly different processing for a slow formation (block 2405) as illustrated in FIG. 24. For example, the search region for mud slowness is initialized differently (block 2440), and the order of the 1D inversion processing for mud slowness and shear slowness is reversed.

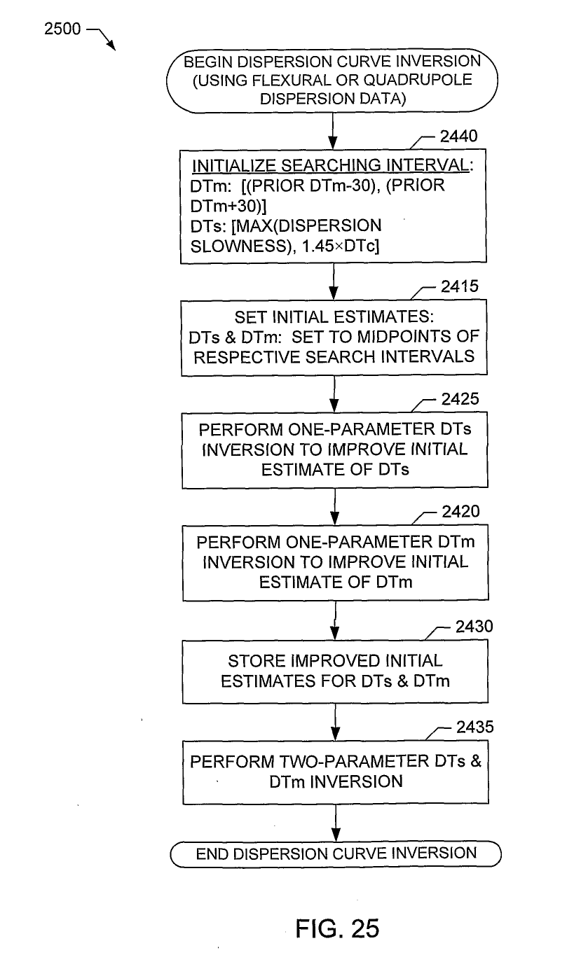

FIG. 25 illustrates an example method 2500 to estimate shear and mud slowness of a formation from dipole or quadrupole dispersion curves. As for the Stoneley case addressed by the method 2400 of FIG. 24, the method 2500 implements a combination of 1D and 2D inversion to estimate the mud and shear slowness. Given the similarities between the methods 2400 and 2500, like blocks are identified using the same reference numerals, and the description of these blocks is provided above in the discussion of method 2400.

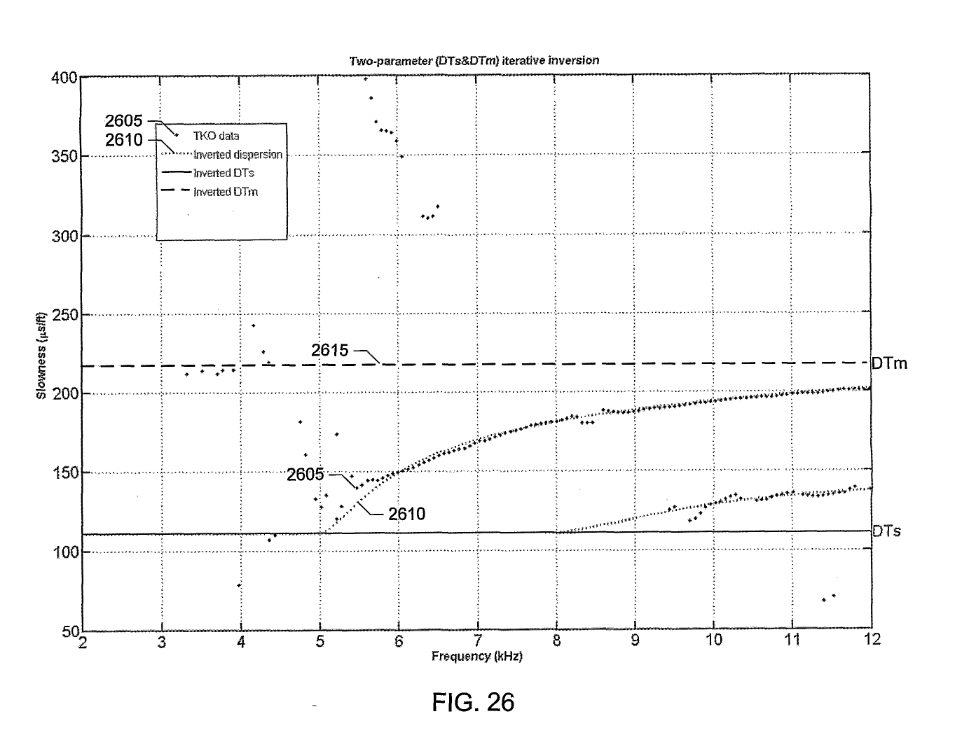

FIG. 26 illustrates an example of two parameter inversion in the case of borehole quadrupole data. Dots 2605 represent the dispersion curve obtained from the matrix pencil method, whereas the dots 2610 represent the dispersion curve obtained from the inversion algorithm. Note the close match between the inverted curve and the computed dispersion (i.e. matrix pencil). A line 2615 presents the inverted DTmud value.

While an example manner of implementing the data processor 600 has been illustrated in FIG. 6, one or more of the elements, processes and/or devices illustrated in FIG. 6 may be combined, divided, re-arranged, omitted, eliminated and/or implemented in any other way. Further, the example wavelet transformer 620, the example stacker 630, the example time-frequency processor 640, the example data analyzer 650, the example filter 660, the example dispersion estimator 670, the example dispersion curve inverter 680, the example output interface 690 and/or, more generally, the example data processor 600 of FIG. 6 may be implemented by hardware, software, firmware and/or any combination of hardware, software and/or firmware. Thus, for example, any of the example wavelet transformer 620, the example stacker 630, the example time-frequency processor 640, the example data analyzer 650, the example filter 660, the example dispersion estimator 670, the example dispersion curve inverter 680, the example output interface 690 and/or, more generally, the example data processor 600 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example data processor 600, the example wavelet transformer 620, the example stacker 630, the example time-frequency processor 640, the example data analyzer 650, the example filter 660, the example dispersion estimator 670, the example dispersion curve inverter 680 and/or the example output interface 690 are hereby expressly defined to include a tangible medium such as a memory, digital versatile disk (DVD), compact disk (CD), etc., storing such software and/or firmware. Further still, the example data processor 600 of FIG. 6 may include one or more elements, processes and/or devices in addition to, or instead of, those illustrated in FIG. 6, and/or may include more than one of any or all of the illustrated elements, processes and devices.

The flowcharts of FIGS. 7, 17, 24 and 25 are representative of example processes that may be executed to implement the example data processor 600, or one or more portions thereof, as illustrated in FIG. 6. In the example flowcharts of FIGS. 7, 17, 24 and 25, the processes represented by each flowchart may comprise one or more programs comprising machine readable instructions for execution by a processor, such as the processor 2812 shown in the example processing system 2800 discussed below in connection with FIG. 28. Alternatively, the entire program or programs and/or portions thereof implementing one or more of the processes represented by the flowcharts of FIGS. 7, 17, 24 and 25 could be executed by a device other than the processor 2812 (e.g., such as a controller and/or any other suitable device) and/or embodied in firmware or dedicated hardware (e.g., implemented by an ASIC, a PLD, an FPLD, discrete logic, etc.). Also, one or more of the programs represented by the flowchart of FIGS. 7, 17, 24 and 25 may be implemented manually. Further, although the example processes are described with reference to the flowcharts illustrated in FIGS. 7, 17, 24 and 25, many other techniques for implementing the example methods and apparatus described herein may alternatively be used. For example, with reference to the flowcharts illustrated in FIGS. 7, 17, 24 and 25, the order of execution of the blocks may be changed, and/or some of the blocks described may be changed, eliminated, combined and/or subdivided into multiple blocks.

As mentioned above, the example processes of FIGS. 7, 17, 24 and 25 may be implemented using coded instructions (e.g., computer readable instructions) stored on a tangible computer readable medium such as a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 7, 17, 24 and 25 may be implemented using coded instructions (e.g., computer readable instructions) stored on a non-transitory computer readable medium, such as a flash memory, a ROM, a CD, a DVD, a cache, a random-access memory (RAM) and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. Also, as used herein, the terms “computer readable” and “machine readable” are considered equivalent unless indicated otherwise.

FIG. 28 is a block diagram of an example processing system 2800 capable of implementing the apparatus and methods disclosed herein. The processing system 2800 can be, for example, a server, a personal computer, a personal digital assistant (PDA), an Internet appliance, a DVD player, a CD player, a digital video recorder, a personal video recorder, a set top box, or any other type of computing device.

The system 2800 of the instant example includes a processor 2812 such as a general purpose programmable processor. The processor 2812 includes a local memory 2814, and executes coded instructions 2816 present in the local memory 2814 and/or in another memory device. The processor 2812 may execute, among other things, machine readable instructions to implement the processes represented in FIGS. 7, 17, 24 and/or 25. The processor 2812 may be any type of processing unit, such as one or more Intel® microprocessors from the Pentium® family, the Itanium® family and/or the XScale® family, one or more microcontrollers from the ARMS and/or PIC® families of microcontrollers, etc. Of course, other processors from other families are also appropriate.

The processor 2812 is in communication with a main memory including a volatile memory 2818 and a non-volatile memory 2820 via a bus 2822. The volatile memory 2818 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 2820 may be implemented by flash memory and/or any other desired type of memory device. Access to the main memory 2818, 2820 is typically controlled by a memory controller (not shown).

The processing system 2800 also includes an interface circuit 2824. The interface circuit 2824 may be implemented by any type of interface standard, such as an Ethernet interface, a universal serial bus (USB), and/or a third generation input/output (3GIO) interface.

One or more input devices 2826 are connected to the interface circuit 2824. The input device(s) 2826 permit a user to enter data and commands into the processor 2812. The input device(s) can be implemented by, for example, a keyboard, a mouse, a touchscreen, a track-pad, a trackball, an isopoint and/or a voice recognition system.

One or more output devices 2828 are also connected to the interface circuit 2824. The output devices 2828 can be implemented, for example, by display devices (e.g., a liquid crystal display, a cathode ray tube display (CRT)), by a printer and/or by speakers. The interface circuit 2824, thus, typically includes a graphics driver card.

The interface circuit 2824 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The processing system 2800 also includes one or more mass storage devices 2830 for storing software and data. Examples of such mass storage devices 2830 include floppy disk drives, hard drive disks, compact disk drives and digital versatile disk (DVD) drives.

As an alternative to implementing the methods and/or apparatus described herein in a system such as the processing system of FIG. 28, the methods and or apparatus described herein may be embedded in a structure such as a processor and/or an ASIC.

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method for processing measured data, comprising:
receiving a time series of measured data obtained by sensing a propagating signal, the propagating signal having passed through a subterranean formation;
transforming the time series to generate a time-frequency representation of the time series; and
processing the time-frequency representation to at least one of reduce noise in the time frequency representation, or enhance a component of the propagating signal present in the time-frequency representation.

2. A method as defined in claim 1, wherein the time series of measured data is obtained by sensing the propagating signal using at least two receivers.

3. A method as defined in claim 1, wherein transforming the time series of measured data comprises performing at least one of a wavelet transform, a Wigner Wille transform or a short time Fourier transform on the time series of measured data to generate the time-frequency representation.

4. A method as defined in claim 1, wherein processing the time-frequency representation comprises stacking a plurality of time-frequency representations generated for a respective plurality of time series of measured data corresponding to a respective plurality of propagating signals generated by successive firings of a source.

5. A method as defined in claim 4, wherein stacking comprises:
applying weight factors to the plurality of time-frequency representations; and
accumulating the weighted time-frequency representations.

6. A method as defined in claim 1, wherein processing the time-frequency representation comprises filtering the time-frequency representation.

7. A method as defined in claim 6, wherein the filtering comprises:
determining a mask corresponding to a first component of the propagating signal, the mask having a shape related to an energy pattern of the first component; and
applying the mask to the time-frequency representation.

8. A method as defined in claim 1, further comprising reconstructing a second time series from the processed time-frequency representation.

9. A method as defined in claim 1, further comprising determining a dispersion curve from the processed time-frequency representation.

10. A method as defined in claim 9, wherein determining the dispersion curve from the processed time-frequency representation comprises:
determining group slowness values at respective frequencies of the processed time-frequency representation;
determining phase slowness values at respective frequencies of the processed time-frequency representation;
determining attenuation values at respective frequencies of the processed time-frequency representation; and
combining the group slowness values, the phase slowness values and the attenuation values to determine the dispersion curve.

11. A method as defined in claim 1, further comprising determining one or more properties of the subterranean formation from a dispersion curve determined from the processed time-frequency representation.

12. A method as defined in claim 11, wherein the one or more properties of the subterranean formation include a shear slowness of the formation.

13. A method as defined in claim 12, wherein the one or more properties of the subterranean formation further include a mud slowness.

14. A method as defined in claim 13, wherein determining the one or more properties of the subterranean formation comprises:
performing single parameter inversions of the dispersion curve determined from the processed time-frequency representation to determine initial estimates of the mud slowness and the shear slowness; and
performing a two-parameter inversion of the dispersion curve determined from the processed time-frequency representation, the two-parameter inversion being initialized using the initial estimates of the mud slowness and the shear slowness determined by performing the single parameter inversions.

15. A tangible article of manufacture storing machine readable instructions which, when executed, cause a machine to at least:
receive a time series of measured data obtained by sensing a propagating signal, the propagating signal having passed through a subterranean formation;
transform the time series to generate a time-frequency representation of the time series; and
process the time-frequency representation to at least one of reduce noise in the time frequency representation, or enhance a component of the propagating signal present in the time-frequency representation.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. An data processor comprising:
a transformer to:
receive a time series of measured data obtained by sensing a propagating signal, the propagating signal having passed through a subterranean formation; and
transform the time series to generate a time-frequency representation of the time series; and
a processor to process the time-frequency representation to at least one of reduce noise in the time frequency representation, or enhance a component of the propagating signal present in the time-frequency representation.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
